(19) United States
(12) Patent Application Publication
(10) Pub. No.: US 2022/0036310 A1
(43) Pub. Date: Feb. 3, 2022

(54) METHOD AND SYSTEM FOR PLANNING ITEM DELIVERIES

(71) Applicant: STARSHIP TECHNOLOGIES OÜ, Tallinn (EE)

(72) Inventor: Ahti HEINLA, Tallinn (EE)

(21) Appl. No.: 17/278,744

(22) PCT Filed: Oct. 9, 2019
(86) PCT No.: PCT/EP2019/077322

§ 371 Date: Mar. 23, 2021

(30) Foreign Application Priority Data
Oct. 9, 2018 (EP) 18199420.3

(51) Int. Cl. G06Q 10/08; G06Q 10/04; G06N 3/12

(52) U.S. Cl. CPC G06Q 10/08355; G06Q 10/0832; G06N 3/126; G06Q 10/047; G06Q 10/0833

(57) ABSTRACT

A method of or for routing delivery items to delivery locations using transport devices includes localizing the plurality of delivery items, determining the delivery locations for the plurality of delivery items and executing a genetic algorithm for outputting a routing plan. The genetic algorithm can be an adapted genetic routing algorithm. The routing system can comprise a computing system that can be configured to execute at least one genetic algorithm for at least one of: assigning the transport devices to the delivery items, assigning the transport devices to times of delivery, and routing the transport devices to the delivery locations. The controlling system can be configured to control the transport devices according to the output of the computing system.

### FIELD

The invention is directed towards planning and optimizing item deliveries. The invention also concerns optimizing multimodal item delivery by using mobile robots as one of item transport methods. The invention is further directed towards applying computer-based methods to optimise item delivery.

### BACKGROUND

Item delivery is used in many different aspects of everyday life, from mail and package delivery to meal or grocery delivery. Transporting or delivering various types of items is playing an ever-increasing role in today's economy.

Coordinating the delivery process can be a complicated task. This is addressed, for example, in U.S. Pat. No. 5,897,629, which discloses a delivery planning system for solving a delivery planning problem, where a plurality of carriers delivers packages from a distribution center to different destinations under given constraints. Also, U.S. Pat. No. 7,251,612 considers the issue, in that it provides computer-based methods and systems for dynamically scheduling the distribution of products and services among a system of routes and timeslots.

Often, the start location of an item to be transported is fairly distant from the desired end location. This leads to the item being transported via several different delivery or transportation devices before reaching the end location, in what is often referred as multimodal item delivery. For example, an item ordered online can originate in a warehouse abroad, be transported by truck to an airport, by plane to the destination country, by truck again to the destination city (or an intermediate storage facility in the vicinity of the end location), and finally by delivery van to the recipient. The last leg of the journey can often result in the highest resource cost per item, as each item can have a different delivery address. That is, energy, labour, and time expenses can be the highest per item for the so-called “last-mile” part of the delivery process or last-mile delivery. Furthermore, transporting each item to the end location by a delivery van results in increased traffic in residential neighbourhoods, longer delivery times, multiple delivery attempts and other undesired effects.

The last-mile delivery problem optimization has also been approached from some angles. For instance, U.S. Pat. No. 7,587,345 discloses a method and system for delivery that establishes a delivery subsector for a distribution facility, adjusts at delivery area within the delivery subsector, plans a flexible delivery route in the delivery area, and completes deliveries.

Further, customizing the delivery process by allowing recipients to select a timeslot for delivery has been discussed in the art. U.S. Pat. No. 8,429,019 discloses a scheduled delivery component configured to receive delivery availability information for multiple shipment carriers.

Recently, mobile robots have been used to address the last-mile problem in item delivery. For example, Starship Technologies has disclosed and launched a mobile robot configured to transport items, such as to deliver them to recipients. The applicant's international patent application WO 2017/064202 A1 discloses such mobile delivery robots. The robots can be semi- or nearly- or fully-autonomous, small in size, operate outside or within usual business hours and/or at times convenient for item recipients and have various other advantages as regards item delivery.

Given one or a plurality (i.e. a fleet) of such mobile delivery robots and one or a plurality of other transport devices, usually with a bigger carrying capacity than the mobile robot, item delivery in a certain neighbourhood can be optimized by using different techniques. For example, items can be delivered by passing through both or multiple delivery or transportation devices, in what is referred as multimodal item delivery. Hence, an optimization problem seeking to maximize efficiency (and/or minimize cost) such that a plurality of mobile robots and other vehicles can deliver a plurality of items to a plurality of recipients, can be solved to increase efficiency and/or minimize cost of the item delivery process.

A version of such optimization problems is the traveling salesman problem (TSP). The TSP objective is to find the shortest possible route, such that, given a plurality of islands a salesman can traverse through each of the islands only once, starting and ending at the same island. Another similar problem, which can be considered as a generalized version of the TSP, is the vehicle routing problem (VRP). The VRP asks to find the shortest set of routes, such that a given fleet of vehicles can deliver items to a given set of delivery locations.

Often optimization problems of such nature (e.g. TSP, VRP) are complex problems, that is, require a lot of computations to be solved (often classified as NP-hard problems), wherein the number of computations required can grow exponentially with the degrees of freedom provided. To find an optimal solution for such problems may take a substantially long time, which can be unfeasible for some applications or may require and consume a lot of processing components and power. Hence, usually when such problems are addressed, they are solved using heuristics or random (usually pseudorandom or metaheuristic) searches for finding optimal or near-optimal or at least feasible solutions. The purpose of such heuristic algorithms is to find a solution which is good enough (i.e. fulfils a set of constraints) at a reasonable amount of time. A class of such algorithms are the genetic algorithms, more specifically, the genetic routing algorithms.

The genetic algorithms can be classified as search-based optimization techniques, or a subset of a larger branch of computation known as evolutionary computation. The genetic algorithms are based on an evolutionary analogy from biology—hence, biological terms are often used to describe steps, processes or components of the algorithm.

A subset of all possible solutions (i.e. the candidate solutions) is often referred (within the terminology of genetic algorithms) as population. The term population and candidate solutions or set of candidate solutions are often used interchangeably (as in this document).

The population consists of chromosomes, also referred as individuals, with each chromosome (or individual or solution) being one candidate solution of the problem. The term chromosome, individual and candidate solution (i.e. one possible solution) are often used interchangeably (as in this document). The chromosome or the characteristics of the solution represented by the chromosome can usually be encoded, such that it can be operated by a machine and a machine-readable code, for example using a binary representation. The encoding of the chromosomes can also facilitate the conduction of genetic operations upon them.

Further, a chromosome comprises genes wherein each gene is an element position of the chromosome. Finally, the value that the gene can take is referred as allele. For example, in the case of a binary representation of a chromosome, the respective genes are the individual bits of the chromosome and the respective allele of the gene can be 0 or 1 (one of the 2 possible binary states). Furthermore, each solution (or individual or chromosome) is evaluated based on a fitness value associated to it, wherein the fitness of a solution is calculated using a fitness function which evaluated the characteristics of a solution. The fitness function may be similar or the same with the objective function, wherein the objective function is what the problem seeks to optimize or solve.

In general, a genetic algorithm begins by initializing the population (i.e. the set of candidate solutions). This can be done by using a random population comprising random solutions—i.e. the individuals are randomly generated. Then, individuals of the population are evaluated using the fitness function. Thus, a fitness value can be associated to each individual (or chromosome). Usually best individuals (the ones with the highest fit) that come up after the evaluation are selected and the others can be discarded. The selected individuals can then be subjects of crossover and mutation operations. Crossover operation consists of combining at least two individuals to produce offspring(s) (i.e. other solutions resulting from the combination of at least two individuals). Mutation consist of altering one individual to produce a mutant solution. Hence, using the selected individuals from the previous population, their offspring and mutant solution resulting from the crossover and mutation operations, a new generation is produced. This new generation can then be evaluated, such that the best of which can be selected, then become subject to crossover and/or mutation operations, then a new generation forms and so on. Hence, the algorithm is iterative, with each iteration being based on a previous generation wherein changes are made and better results can be produced. Usually a terminating condition, such as, number of iterations or the fitness become better than a threshold, can be used to conclude the execution of the algorithm.

Genetic algorithms are used to solve different classes of problems, especially, optimization problems. Genetic algorithms are particularly efficient when the search space is large. For instance, genetic algorithms, can be used to optimize the routes that a fleet of mobile robots and/or other vehicles can follow in order to distribute items to a plurality of recipients. However, genetic algorithms are general in nature and they can be used for a large class of problems. Thus, simply applying them to solve a particular problem can often be inefficient. Domain (or problem) specific configurations, such as, domain specific crossovers or mutations, can improve performance and results of the algorithm.

### SUMMARY

In light of the above, it is an object of the present invention to provide a method and a system for optimizing item delivery using a combination of mobile delivery robots and at least one further type of item transport device.

These objects are fulfilled by the method and system of the present invention.

In a first embodiment, the invention relates to a method for routing a plurality of delivery items to a plurality of delivery locations by a plurality of transport devices. In the present context, transport devices can be devices configured for carrying and transporting at least one delivery item. Given a plurality of transport devices, delivering a plurality of delivery items to a plurality of delivery locations can be performed in different ways. The difference between the multiple ways a plurality of delivery items can be delivered to a plurality of delivery locations can consist on at least one of: the time ordering of the deliveries of each item, the transport devices used, the assignment between transport devices and delivery items, the assignment between transport devices and times of delivery, and the respective routes used for delivering the items. Different ways of deliveries (or routing plans) can comprise different characteristics. For example, some of them may allow for all the delivery items to be delivered, some of them may comprise a smaller length of routes used for delivering the items, some of them may deliver the items in a smaller amount of time. In general, some routing plans (or ways of delivering the items) can be more efficient or preferable or advantageous than other routing plans.

Furthermore, the number of delivery items and/or delivery locations and/or transport devices and/or routes to deliver the delivery items to the respective delivery location can be large. As a consequence, the number of possible routing plans can be large, too. In general, the number of routing plans available can increase with (however not limited to) the number the number of delivery items and/or delivery locations and/or transport devices and/or routes to deliver the delivery items to the respective delivery location. This can render the finding of an efficient route (e.g. the most efficient route) as a computationally expensive task, that is, it may take a large number of computations (hence a relatively long time) for determining an efficient route which may be unfeasible for the application (i.e. calculating a routing plan for delivering items).

The present invention provides a method of determining a routing plan for delivering the plurality of items to the plurality of delivery locations using a plurality of transport devices. Further, the current method can allow for the automation of such a task, as it can be carried out in the form of machine instructions executed by a computing machine. Further still, the current method can allow for the calculation of the routing plan in a feasible time. As it will become clear by the following embodiments, the method can allow for setting different criteria or constraints for the routing plan as well as for setting the time available to determine the routing plan.

Hence, the method can be advantageous for use particularly for item delivery or by an organization offering the service of item delivery, even more particularly for last mile item delivery. The current method can allow, e.g. the organization offering the service of item delivery, to calculate efficient routing plan, that can decrease the cost of item delivery. The current method can also determine such routing plans in a feasible amount of time, hence contributing on increasing the client (i.e. recipient or user) satisfaction—a smaller time required for calculating the routing plan and/or an efficient routing plan may avoid or decrease item delivery delays. Further still, the current method can allow e.g. the organization offering the service of item delivery, to set at least one characteristic or constraint which the calculated routing plan should comprise. Hence, the method can facilitate the carrying of the deliveries according to set targets, e.g. business plans, such as, cost spent for delivery.

The method comprises the steps of localizing the plurality of delivery items and determining the delivery locations for the plurality of delivery items. In some embodiments, the method can comprise the step of determining a respective time of delivery or a respective time windows of delivery for at least one of the plurality of delivery items. This can allow for the formulation of the “problem to be solved”. That is, it can be determined what is the number of delivery items, where are the delivery items positioned (e.g. in a shop or in a storing facility) and where the items should be delivered (e.g. the address of the recipient). Further, in some embodiment also the time of delivery, which can be a specific time or time window, can be determined.

The method further comprises the step of executing a genetic algorithm for outputting a routing plan. In this step, the transport devices can be assigned to delivery items (i.e. for each item it can be determined which transport device will be used to transport that item). Alternatively or additionally, in this step the times of delivery can be assigned to transport devices (i.e. when should the transport devices deliver the delivery items they can be assigned to). Alternatively or additionally still, in this step the routing of the transport devices to the delivery locations can be determined (i.e. which route should the transport devices follow to reach the delivery locations). In other words, in this step a routing plan can be determined and the routing plan can preferably comprise the required information to deterministically carry out the delivery of the items.

Different kinds or types of transport devices can be provided. The difference between the different types or kinds can concern at least one of: the sizes of the transport devices, the number of delivery items the transport devices can transport, the size of delivery items the transport devices can transport and the way of travel they are configured to use. Based on the aforementioned differences, the transport devices can be classified on different categories. This can allow a distinction to be made between different ways of carrying out the delivery. That is, deliveries can be carried out using a transport device from a specific category or using multiple transport devices from different categories. When multiple transport devices from different categories are used, different parts of item delivery can be defined wherein each part can be carried out using transport devices from a category.

In some embodiments, a first and a second transport device can be provided. That is, two different categories of transport devices can be provided, wherein each category can comprise one or more transport devices. The first transport device (i.e. the first category) can be a mobile robot (or mobile robots). The term “first transport device” and mobile robot are used interchangeably throughout the text. The second transport device (i.e. the second category) can be a transport apparatus (or transport apparatuses). The term “second transport device” and transport apparatus are used interchangeably. Further, the term “transport device” is inclusive of the first and second transport device (i.e. the mobile robot and transport apparatus). Further still a distinction is herein made between the term “transport apparatus” which refers only to the second transport devices and the term “transport devices” which refers simultaneously to the first transport devices and the second transport devices.

The difference, between the transport apparatus and the mobile robot can comprise at least one of: the transport apparatus can comprise a bigger carrying capacity than the mobile robot and the transport apparatus can be configure to transport at least one mobile robot.

The mobile robot can carry at least one delivery item, preferably up to 10 delivery items. A single transport apparatus can generally carry more delivery items than a single mobile robot. The transport apparatus can carry at least one delivery item, preferably up to 200 delivery items.

The mobile robot can be a fully or nearly autonomous mobile robot. For example, the autonomy level of the mobile robot can be between the levels 1 to 5, as defined by the Society of Automotive Engineers (SAE) in J3016—Autonomy Levels. In some embodiments, the mobile robot can be a fully autonomous mobile robot (i.e. autonomy level 5 according to SAE). That is, the fully autonomous mobile robot can navigate, drive and execute other functionalities related to its operation on its own without a human operator controlling it. In some embodiments, the mobile robot can be nearly- or semi-autonomous (e.g. any of autonomy levels 1 to 4 according to SAE). That is, the nearly autonomous mobile robot can in some instance and/or for some functionalities operate on its own and in some other instance and/or other functionalities be assisted by a human operator

The mobile robot can be configured to travel in public roads, driveways, bike lanes and sidewalks. Generally, the mobile robot drives in sidewalks or bike lanes, however in particular instance may be required to cross or travel in public roads or driveways. The transport apparatus can be configured to generally travel in public roads. In some instances, the transport apparatus can travel (or park for distribution of delivery items to robots) on driveways or side of the roads or parking places.

The mobile robot can be configured to generally travel at low speeds, such as, 0-30 km/h, or no more than 8 km/h, or no more than 6 km/h. The transport apparatus can be configured to travel at low and high speeds, such as 0-150 km/h.

The transport apparatus can be configured to carry at least one mobile robot, preferably at most 30 mobile robots, more preferably at most 20 mobile robots.

In the above embodiments, different distinctions between the two types or categories of transport devices are made. The method, is generally described with reference to the two types of transport devices discussed in the above embodiments. Nevertheless, it will be understood that more than two types of transport devices, or transport devices comprising other difference can be used with the method of the present invention without changing the general principle of the invention.

As discussed in a preceding paragraph the method comprises the step of localizing the plurality of delivery items. This step can comprise determining an item loading location for the delivery items. The item loading location can be a location wherein the delivery items can be loaded to at least one transport device. For each delivery item, the respective item loading location can be determined. The item loading location can be a storage facility, wherein a plurality of delivery items can be originated, gathered and/or stored before distributing for delivery. The item loading location can be a facility offering or selling the delivery items.

The method can further comprise receiving at least one request for item delivery from at least one user (also referred as recipient). The request for item delivery can comprise a description and/or identification for at least one item that can be requested by the user. This can allow the identification of the items to be delivered. The request for item delivery can further comprise a location attribute that can allow the user to specify a preferred location for receiving the delivery item(s). This can facilitate the step of determining the delivery location for the plurality of delivery items. Additionally, the request for item delivery can comprise a time attribute, wherein the at least one user can specify a preferred time or time window for receiving the delivery item. This can facilitate the step of determining a respective time of delivery or a respective time window of delivery for at least one of the plurality of delivery items. However, at least one or all of the times of deliveries or time windows of deliveries can be determined by the genetic algorithm, e.g. when not all user specify a time of delivery or when the feature of specifying the time of delivery is not provided.

In some embodiments, the step of receiving at least one request for item delivery from at least one user (discussed above) can comprise the at least one user ordering an item.

In some embodiments, the step of receiving at least one request for item delivery from at least one user (discussed above) can comprise the at least one user providing the request for item delivery using a user terminal. The user terminal can be a PC, laptop, smartphone, notebook, tablet or any other similar device. The user terminal can be remotely connected (e.g. through Internet connection) with a server or another terminal, allowing the user to provide or communicate the request for item delivery to the server or the other terminal. The user terminal can be personal device of the user or a device provided by the party offering the item and/or offering the item delivery service. The user terminal can be remote (e.g. a smartphone, notebook, laptop, tablet, or the like) or can be a machine installed in a fixed location.

Alternatively or additionally, the user can also provide the request for item delivery by filling a form (e.g. in a paper format) or by verbally communicating the request either in person or remotely e.g. through a cell phone.

In some embodiments, the step of executing the genetic algorithm can be performed iteratively. In each iteration, a generation can be generated and wherein said generation can be a representation of the delivery plan. For example, the generation can be an encoded version of the routing plan. The code used to encode the routing plan into a generation (also referred as population) can be a machine-readable code.

The step of generating a generation can comprise combining at least two previous generations, wherein the combination of at least two previous generations can comprise inheriting features from the at least two combined previous generations, such as, from each of the at least two combined previous generations.

A previous generation herein refers to a generation that is generated during an iteration that occurred before a current iteration. That is, a previous generation is relative to a current iteration (or current generation) wherein the previous generation is generated before the current generation is generated or the current iteration initiates. In this context, a next generation refers to a generation that will be generated during an iteration that will occur after the current iteration. That is, a next generation is relative to a current iteration (or current generation) wherein the next generation will be generated after the current generation is generated or the current iteration terminates.

The step of generating a generation can alternatively or additionally comprise performing changes on a previous generation, such as, randomly changing a feature of a previous generation.

The step of generating a generation can alternatively or additionally comprise inheriting some or at least one feature(s) from a previous generation and recalculating rest of the features. A feature of a generation can be a feature of a routing plan such as (and not limited to): an assignment of the transport devices to delivery items, an assignment of transport devices to times of delivery, a routing of the transport device to the delivery location (or any intermediate location). That is, a feature of a generation (interchangeably used with “the feature of a routing plan”) can be a characteristic of the routing plan or an information comprised by the routing plan that specifies an action to be carried out during the delivery process.

The step of generating a generation can alternatively or additionally comprise adding features to a previous generation.

The step of generating a generation can alternatively or additionally comprise removing features from a previous generation.

The step of generating a generation (i.e. the genetic algorithm) can also comprise domain specific changes on at least one previous generation. The domain specific changes consider information related to the application of the current method (i.e. routing a plurality of delivery items to a plurality of delivery locations by a plurality of transport devices). Such domain specific changes can comprise randomly assigning a transport device to a delivery item, hence information related to the transport devices used and items to be delivered can be considered.

Alternatively or additionally, the domain specific changes can comprise re-assigning a delivery item from one transport device to another.

Alternatively or additionally, the domain specific changes can comprise re-assigning at least two delivery items with different assigned transport devices to same transport device.

Alternatively or additionally, the domain specific changes can comprise assigning a delivery item from being delivered using one transport device to being delivered using different kinds of transport devices.

Alternatively or additionally, the domain specific changes can comprise adding a delivery item and/or a respective route for delivering the delivery item.

Alternatively or additionally, the domain specific changes can comprise removing a delivery item and/or respective route for delivering the delivery item. Hence, domain-specific information related to respective routed for delivering the delivery items can be considered.

Alternatively or additionally, the domain specific changes can comprise swapping the time-wise ordering of two successive deliveries for a transport device. Hence, domain-specific information related to the times of delivery of the delivery items can be considered.

Alternatively or additionally, the domain specific changes can comprise adding to the route for delivering a delivery item an intermediate stop at an energy station for providing energy to the assigned transport devices to complete the delivery of the respective delivery item. Hence, domain-specific information related to the energy comprised by the transport devices and the presence of energy station can be considered.

Alternatively or additionally, the domain specific changes can comprise combining at least two routes for delivering at least two delivery items into a single route.

In some embodiments, the efficiency and constraint fulfilment of each generation (or each routing plan generated) can be determined. This can allow multiple generations (or routing plan) to be evaluated and compared with each other. Hence, the algorithm can be able to output a routing plan that is more efficient that the other calculated routing plans (during the iterations). To put it simply, determining an efficiency and constraint fulfilment for each generation, can allow for the optimization of the efficiency and constraint fulfilment.

The efficiency of the constraint fulfilment of a generation can consider different features of the generation and/or the specific application (e.g. for minimizing delivery latency it can be advantageous to express efficiency in terms of time required to deliver the item and set the optimization target of the genetic algorithm to minimize the time required to deliver the items).

The efficiency and constraint fulfilment of a generation can be based on at least one of: distance travelled by the transport devices to deliver the plurality of delivery items, time spent to deliver the plurality of delivery items, energy consumed by the transport devices to deliver the plurality of delivery items, number of transport devices required for delivering the plurality of delivery items, number of human employees that can be involved in the process of delivering the plurality of delivery items, accordance with regulations or laws, such as, traffic laws and cost of carrying out the delivery routing plan (which may or may not depend on the aforementioned aspects).

The genetic algorithm can be executed until a termination conditioned is fulfilled. In other words, a termination condition can be specified or provided to the genetic algorithm before or during execution which can allow the genetic algorithm to determine when to terminate execution. The termination condition is advantageous, as it can avoid execution of the genetic algorithm indefinitely or for very long time.

The termination condition can be specified as a time limit. In such embodiments, the genetic algorithm can be allowed to execute for a maximum time corresponding to the specified time limit. Before or when the time limit of executing is reached the genetic algorithm terminates execution and a routing plan can be output, preferably the routing plan with the best efficiency or constraint fulfilment that is achieved during the execution of the genetic algorithm.

Alternatively or additionally, the termination condition can comprise a minimum required efficiency and the genetic algorithm can comprise comparing the efficiency of a generation with the minimum required efficiency and terminating execution if the efficiency of a generation is not smaller than the minimum required efficiency. At termination, the genetic algorithm can output the routing plan according to the generation that comprised an efficiency not smaller than the minimum required efficiency.

Thus, the method can allow for setting different criteria or constraints or expected efficiencies or costs for the routing plan as well as for setting the time available to determine the routing plan.

During the output of the routing plan at least one generation can be considered. Preferably the generation providing the best efficiency and/or constraint fulfilment can be taken into consideration to output the delivery plan. In some instances, but not necessarily, it can be the generation of the last iteration.

In some embodiments, the execution of the genetic algorithm is repeated during travel of transport devices. Further still, in some embodiments, the routing plan can be changed during the travel of the transport devices. As the execution time of the genetic algorithm can be an important factor for calculating an efficient routing plan, repeating (or continuing) the execution of the genetic algorithm during the transport of the devices can provide more execution time and hence, a more efficient (or optimized) routing plan can be generated. Further, allowing the routing plan to be changed during the travel of the transport devices can make the actual delivery process more efficient. In a specific example, firstly a preliminary routing plan can be generated by the genetic algorithm. While, the preliminary routing plan is being executed (e.g. while items are loaded in transport devices and/or are items are being transported) the genetic algorithm can be kept executing. If a better routing plan (e.g. with a better efficiency and better constraint fulfilment) is found, it can be output. If feasible, the preliminary routing plan can be changed or updated with the more efficient one and the delivery of the items is carried out according to the later generated routing plan (i.e. to the updated routing plan).

In some embodiments, the method can further comprise delivering the plurality of delivery items to the respective delivery locations using at least one mobile robot.

In some embodiments, the method can further comprise delivering the plurality of delivery items to the respective delivery locations using at least one transport apparatus.

In some embodiments, the method can further comprise delivering the plurality of delivery items to the respective delivery locations using at least one mobile robot and at least one transport apparatus.

In some embodiments, the method can further comprise transferring at least one delivery item from a transport apparatus to a mobile robot. Thus, the item delivery can be performed by first transporting the item from a loading location to a transfer location using a transport apparatus. In the transfer location the item can be unloaded from the transport apparatus and loaded to a mobile robot (i.e. can be transferred). Further, the mobile robot can transport the item to the respective delivery location.

In some embodiments, the method can further comprise the transport apparatus carrying at least one mobile robot and wherein the at least mobile robot can carry at least one delivery item. In such embodiments, the transport apparatus is configured for carrying at least one mobile robot. Thus, item delivery can be carried out by the transport apparatus carrying and transporting at least one mobile robot to an intermediate location, unloading the at least one mobile robot at the intermediate location and the at least one mobile robot transporting the at least one delivery item to the respective delivery locations.

As discussed in a preceding paragraph, the method comprises executing a genetic algorithm for outputting a routing plan. In some embodiments, the step of executing the genetic algorithm for outputting a routing plan can be executed in a data processing device.

The data processing device can comprise a processing unit (such as processors). In some embodiments, the data processing device can be part of a server such a cloud server.

In some embodiments, the genetic algorithm can be executed in a computing system, preferably in a cloud computing system. The computing system can comprise the data processing device.

In some embodiments, the step of determining the delivery locations for the plurality of delivery items can comprise the data processing device receiving the delivery location. For example, the data processing device can receive the delivery location from a user, more particularly from a user terminal of the user. In another example, the user can generate a request for item delivery (e.g. order an item) by operating a user terminal and the request for item delivery can be communicated from the user terminal to the data processing device.

In some embodiments, the step of determining the delivery locations for the plurality of delivery items can comprise the computing system (which may comprise the data processing device) receiving the delivery location. For example, the computing system can receive the delivery location from a user, more particularly from a user terminal of the user. In another example, the user can generate a request for item delivery (e.g. order an item) by operating a user terminal and the request for item delivery can be communicated from the user terminal to the computing system.

In some embodiment the step of localizing the plurality of delivery items can comprise the data processing device receiving the locations of the delivery items. For example, the data processing device can receive the item locations from a user, more particularly from a user terminal of the user. Alternatively, data processing device can receive a request for item delivery (generated by a user in a user terminal) and can infer the location of the delivery items based on the request for item delivery. For example, the data processing device can infer the location of a delivery item based on a name, ID, address or other data related to item provider.

Further, the method for routing a plurality of delivery items to a plurality of delivery locations by a plurality of transport devices can be a computer implemented method.

The execution of the genetic algorithm for outputting an item delivery routing plan in a data processing device (or server) and/or the configuration of the method as a computer implemented method can facilitate the automation of the tasks (or reduction of tasks performed by humans) required for routing a plurality of delivery items to a plurality of delivery locations by a plurality of transport devices.

In some embodiments, the method can comprise delivering the delivery items using at least one delivery system. The delivery system can comprise the plurality of transport devices. In some embodiments, the delivery system can comprise at least one mobile robot. In some other embodiments, the delivery system can comprise at least one transport apparatus. Generally, the transport apparatus can comprise a larger capacity then the mobile robot. Furthermore, the mobile robot can be configured to generally drive on sidewalks at lower speeds, while the transport apparatus can be configured to generally drive on vehicle roads.

In some embodiments, the method can comprise the delivery system delivering the plurality of the delivery items according to the routing plan. The method can further comprise transmitting the routing plan to the delivery system. That is, an optimized routing plan can be generated by executing a genetic routing algorithm and the delivery system can efficiently deliver the plurality of delivery items using the generated routing plan.

In embodiments wherein a data processing device executes the genetic routing algorithm for outputting a routing plan, the method can comprise transmitting the routing plan to the delivery system. As such, a communication link can be provided between the data processing device and the delivery system. The communication link can preferably be configured for remote data transmission. In other words, a data processing device can be configured for computing the routing plan and the delivery system can be configured for carrying out the delivery of items based on the routing plan.

In some embodiments, a controlling system can be provided. In such embodiments, the method can comprise performing the step of localizing the plurality of delivery items in the controlling system. That is, the method can comprise the controlling system localizing the plurality of delivery items. The controlling system can further communicate or transmit the location of the delivery items to a computing system and/or to a data processing device.

This is particularly advantageous in embodiments wherein a data processing device (and/or the computation system) executes the genetic routing algorithm for outputting a routing plan.

Furthermore, the controlling system can further determine the delivery location for the plurality of delivery items. The controlling system can further communicate or transmit the delivery locations to a computing system and/or to a data processing device. This is particularly advantageous in embodiments wherein a data processing device (and/or the computation system) executes the genetic routing algorithm for outputting a routing plan.

In some embodiments, the controlling system can communicate or transmit logistics data to a computing system and/or to a data processing device. The logistics data can describe or provide information regarding the plurality of transport devices. For example, logistics data may specify the number of the mobile robots and/or transport apparatuses of the delivery system that can be available. Logistics data may further comprise constraints regarding capacities of the transport devices, maximum distance that can be travelled by each transport device, working hours of employees of delivery system that can limit the time span of delivery process, map data of the delivery area wherein deliveries are to be performed, constraints on paths on the delivery area that can be followed, maximum tolerable cost, definition of the cost (e.g. in terms of distance travelled by the transport devices and number of deliveries performed) etc. Transmitting the logistics data to a computing system and/or to a data processing device can be particularly advantageous when the computing system and/or the data processing device execute the genetic routing algorithm for outputting the routing plan. This computing system and/or the data processing device can utilize the logistics data to generate an efficient routing plan.

In some embodiments, the method can comprise the controlling system receiving at least one request for item delivery from at least one user terminal. In some embodiments, a user generates the request for item delivery with a corresponding user terminal. For example, the user can order an item using a user terminal. The request for item delivery can be transmitted from the user terminal to the controlling system. Alternatively or additionally, the request for item delivery can be transmitted from the user terminal to the computing system and/or to a data processing device.

In a second embodiment, the invention discloses a routing system configured for routing a plurality of delivery items to a plurality of delivery locations by a plurality of transport devices. The routing system comprises a controlling system configured to localize the delivery item (i.e. initial position) and delivery locations. That is, the controlling system can be configured to determine and/or store the respective locations of the delivery items and the respective delivery locations of the delivery items. Each delivery item can be delivered from the respective initial position to the respective delivery location.

Further, the routing system comprises a computing system that is configured to execute at least one genetic algorithm for at least one of: assigning the transport devices to the delivery items, assigning the transport devices to times of delivery and routing the transport devices to the delivery locations. In other words, the computing system can output a routing plan for delivering the delivery items to the respective delivery locations.

The controlling system is further configured to control the transport devices according to the output of the computing system. Thus, the delivery of the items can be carried out by the transport devices according to the routing plan output by the computing system.

The routing system can be advantageous as it can carry out the method according to the first embodiment.

In some embodiments, the controlling system can be configured to determine a respective time of delivery or a respective time window of delivery for at least one of the plurality of delivery items.

In some embodiments, the routing system can comprise different kinds or types of transport devices. The difference between the different types or kinds can concern at least one of: the sizes of the transport devices, the number of delivery items the transport devices can transport, the size of delivery items the transport devices can transport and the way of travel they are configured to use. Based on the aforementioned differences, the transport devices can be classified on different categories. This can allow a distinction to be made between different ways of carrying out the delivery. That is, deliveries can be carried out using a transport device from a specific category or using multiple transport devices from different categories. When multiple transport devices from different categories are used, different parts of item delivery can be defined wherein each part can be carried out using transport devices from a category.

In some embodiments, the routing system can comprise a first transport device and a second transport device. That is, two different categories of transport devices can be provided, wherein each category can comprise one or more transport devices. The first transport device (i.e. the first category) can be a mobile robot (or mobile robots). The second transport device (i.e. the second category) can be a transport apparatus (or transport apparatuses). The difference, between the transport apparatus and the mobile robot can comprise at least one of: the transport apparatus can comprise a bigger and/or more voluminous carrying capacity than the mobile robot and the transport apparatus can be configure to transport at least one mobile robot.

The mobile robot can carry at least one delivery item, preferably up to 10 delivery items. A single transport apparatus can generally carry more delivery items than a single mobile robot. The transport apparatus can carry at least one delivery item, preferably up to 200 delivery items.

The mobile robot can be a fully or nearly autonomous mobile robot. For example, the autonomy level of the mobile robot can be between the levels 1 to 5, as defined by the Society of Automotive Engineers (SAE) in J3016—Autonomy Levels. In some embodiments, the mobile robot can be a fully autonomous mobile robot (i.e. autonomy level 5 according to SAE). That is, the fully autonomous mobile robot can navigate, drive and execute other functionalities related to its operation on its own without a human operator controlling it. In some embodiments, the mobile robot can be nearly- or semi-autonomous (e.g. any of autonomy levels 1 to 4 according to SAE). That is, the nearly autonomous mobile robot can in some instance and/or for some functionalities operate on its own and in some other instance and/or other functionalities be assisted by a human operator

The mobile robot can be configured to travel in public roads, driveways, bike lanes and sidewalks. Generally, the mobile robot drives in sidewalks or bike lanes, however in particular instance may be required to cross or travel in public roads or driveways. The transport apparatus can be configured to generally travel in public roads. In some instances, the transport apparatus can travel (or park for distribution of delivery items to robots) on driveways or side of the roads or parking places.

The mobile robot can be configured to generally travel at low speeds, such as, 0-30 km/h, or no more than 8 km/h, or no more than 6 km/h. The transport apparatus can be configured to travel at low and high speeds, such as 0-150 km/h.

The transport apparatus can be configured to carry at least one mobile robot, preferably at most 30 mobile robots, more preferably at most 20 mobile robots.

In the above embodiments, different distinctions between the two types or categories of transport devices are made. The routing system, is generally described with reference to the two types of transport devices discussed in the above embodiments. Nevertheless, it will be understood that more than two types of transport devices, or transport devices comprising other difference can be comprised by the routing system of the present invention without changing the general principle of the invention.

In some embodiments, the routing system can comprise an item loading location, wherein the delivery items can be loaded to at least one transport device. The item loading location can be a location wherein the delivery items can be loaded to at least one transport device. For each delivery item, the respective item loading location can be determined. The item loading location can be a storage facility, wherein a plurality of delivery items can be originated, gathered and/or stored before distributing for delivery. The item loading location can be a facility offering or selling the delivery items.

In some embodiments, the controlling system of the routing system can be configured to receive at least one request for item delivery from at least one user. The request for item delivery can comprise a location attribute wherein the user can specify a preferred location for receiving the delivery item or a preferred location for delivering the delivery item. In some embodiments, the request for item delivery can also comprise a time attribute wherein the at least one user can specify a preferred time or time window for receiving the delivery item.

In some embodiments, the routing system can further comprise a user terminal, that can be configured to facilitate a user to provide a request for item delivery to the controlling system. The user terminal can be a PC, laptop, smartphone, notebook, tablet or any other similar device. The user terminal can be remotely connected through a remote data connection (e.g. through Internet connection) with the controlling system, allowing the user to provide or communicate the request for item delivery to the controlling system. The user terminal can be personal device of the user or a device provided by the party offering the item and/or offering the item delivery service. The user terminal can be remote (e.g. a smartphone, notebook, laptop, tablet, or the like) or can be a machine installed in a fixed location.

The computing system can comprise a data processing device. The data processing device can facilitate the execution of the at least one genetic algorithm. The data processing device can comprise a processing unit (such as processors). In some embodiments, the data processing device can be part of a server such a cloud server.

In some embodiments, the computing routing system can be configured to receive logistic data and delivery request data. The logistic data can comprise data related to the transport devices. For example, the logistic data can specify the number of transport devices, the categories of transport devices, the availability of the transport devices, the capacity of the transport devices, the maximum travelling distance of the transport devices, etc. The delivery request data can comprise data related to the delivery items (e.g. ID of the delivery items and/or of the recipient, initial position of the delivery items, type or category of delivery items, etc.) and respective delivery locations for the delivery items. Additionally, the delivery request data can comprise respective times of delivery for each or some of the delivery items.

The computing system can be configured to output a routing plan. The routing plan can comprise instructions related on how to deliver a plurality of delivery items to a plurality of delivery locations by a plurality of transport devices. The delivery plan can comprise for each delivery item a respective delivery location, a respective time of delivery, assigned transport devices for delivering the delivery item and assigned route for delivering the delivery item.

Further, the controlling system can be configured to receive the delivery plan that can be calculated and output by the computing system. For example, the controlling system and the computing system can be configured for remote data transmission with each-other.

In some embodiments of the routing system, at least one transport device can be fully-autonomous and the controlling system can provide the assigned delivery tasks by the computing system to the at least one fully-autonomous transport device and the at least one fully-autonomous transport device autonomously can complete the assigned delivery task according to the output of the computing system.

In some embodiments of the routing system, at least one transport device can be nearly-autonomous and the controlling system can provide the assigned delivery tasks by the computing system to the at least one nearly-autonomous transport device and the at least one nearly-autonomous transport device assisted by the controlling system can complete the delivery task according to the output of the computing system.

In some embodiments, the controlling system can comprise a remote controller configured to facilitate a human operator to remotely assist at least one nearly-autonomous transport device.

In a third embodiment, the invention relates to the use of the system according to the second embodiment for carrying out the method of the first embodiment.

In a fourth embodiment, the invention relates to the use of the system according to the second embodiment and the method of the first embodiment for delivering a plurality of items, preferably for performing last-mile delivery.

In a fifth embodiment, the invention relates to the use of the system according to the second embodiment and the method of the first embodiment for delivering a plurality of items in a campus, preferably a college and/or university campus.

The present invention also relates to the following numbered embodiments.

### Numbered Embodiments

Below, method embodiments will be discussed. These embodiments are abbreviated by the letter “M” followed by a number. Whenever reference is herein made to “method embodiments”, these embodiments are meant.
M1. A method for routing a plurality of delivery items to a plurality of delivery locations by a plurality of transport devices, the method comprising the steps of:
   a. localizing the plurality of delivery items (5);
   b. determining the delivery locations (33) for the plurality of delivery items (5); and
   c. executing a genetic algorithm (50) for outputting a routing plan (15) comprising at least one of:
      i. assigning the transport devices to the delivery items (5); and
      ii. assigning the transport devices to times of delivery (35); and
      iii. routing the transport devices to the delivery locations (33).
M2. Method according to the preceding embodiment, wherein step b. further comprises determining a respective time of delivery (35) or a respective time window of delivery (35) for at least one of the plurality of delivery items (5).

### Transport Devices

M3. Method according to any of the preceding method embodiments, further comprising the step of providing different kinds of transport devices, the difference concerning at least one of:
   i. the sizes of the transport devices;
   ii. the number of delivery items (5) the transport devices transport;
   iii. the size of delivery items (5) the transport devices transport;
   iv. the way of travel they are configured to use.
M4. Method according to the preceding embodiment, wherein the step of providing different kinds of transport devices comprises providing a first transport device (10) and a second transport device (20), wherein
   i. the first transport device (10) is a mobile robot (10); and
   ii. the second transport device (20) is a transport apparatus (20); and
   iii. at least one of:
      the transport apparatus (20) comprises a more voluminous carrying capacity than the mobile robot (10), and
      the transport apparatus (20) is configured to transport one or more mobile robots (10).
M5. Method according to the preceding embodiment, wherein the mobile robot (10) carries at least one delivery item (5), preferably up to 10 delivery items (5).
M6. Method according to any of the 2 preceding embodiments, wherein the mobile robot (10) is a fully- or nearly-autonomous mobile robot (10).
M7. Method according to any of the 3 preceding embodiments, wherein the mobile robot (10) travels in public roads, driveways, bike lanes and sidewalks.
M8. Method according to any of the 4 preceding embodiments, wherein the mobile robot (10) travels at low speeds, such as, 0-30 km/h, or no more than 8 km/h, or no more than 6 km/h.
M9. Method according to any of the 5 preceding embodiments, wherein the transport apparatus (20) carries at least one delivery item (5), preferably up to 200 delivery items (5).
M10. Method according to any of the 6 preceding embodiments, wherein the transport apparatus (20) carries at least one mobile robot (10), preferably at most 30 mobile robots (10), more preferably at most 20 mobile robots (10).
M11. Method according to any of the 7 preceding embodiments, wherein the transport apparatus (20) travels in public roads.
M12. Method according to any of the 8 preceding embodiments, wherein the transport apparatus (20) travels at low and high speeds, such as 0-150 km/h.

### Item Loading Location

M13. Method according to any of the preceding method embodiments, wherein step a. comprises determining the item loading location (1) for the delivery items (5) wherein the delivery items (5) are loaded to at least one transport device.
M14. Method according to the preceding embodiment, wherein the item loading location (1) is an item storage facility (1).
M15. Method according to any of the 2 preceding embodiments, wherein the item loading location (1) is a facility (1) offering, such as selling, the delivery items (5).

### Request for Item Delivery

M16. Method according to any of the preceding method embodiments, wherein step b. comprises receiving at least one request for item delivery (31) from at least one user (30) and wherein the request for item delivery (31) comprises a location attribute (33) wherein the at least one user (30) specifies a preferred location for receiving the delivery item (5).
M17. Method according to the preceding embodiment, wherein the request for item delivery (31) comprises a time attribute (35) wherein the at least one user (30) specifies a preferred time or time window for receiving the delivery item (5).
M18. Method according to any of the 2 preceding embodiments, wherein the step of receiving at least one request for item delivery (31) from at least one user (30) comprises the at least one user (30) ordering an item.
M19. Method according to any of the 3 preceding embodiments, wherein the step of receiving at least one request for item delivery (31) from at least one user (30) comprises the at least one user (10) providing the request for item delivery (31) using a user terminal (300).

### Routing Algorithm

M20. Method according to any of the preceding method embodiments, wherein step c. is performed iteratively and in each iteration a generation (5100) is generated and wherein said generation (5100) is a representation of the delivery plan (15).
M21. Method according to the preceding embodiment, wherein the step of generating a generation (5100) comprises at least one of:
   i. combining at least two previous generations (5100), wherein the combination of at least two previous generations comprises inheriting features from the at least two combined previous generations (5100), such as, from each of the at least two combined previous generations (5100);
   ii. performing changes on a previous generation (5100), such as, randomly changing a feature of a previous generation (5100);
   iii. inheriting some features from a previous generation (5100) and recalculating rest of the features;
   iv. adding features to a previous generation (5100);
   v. removing features from a previous generation (5100).
M22. Method according to any of the 2 preceding embodiments, wherein the step of generating a generation (5100) comprises performing changes on a previous generation (5100) said changes comprising at least one of:
   i. randomly assigning a transport device to a delivery item (5);
   ii. re-assigning a delivery item (5) from one transport device to another;
   iii. re-assigning at least two delivery items (5) with different assigned transport devices to same transport device;
   iv. assigning a delivery item (5) from being delivered using one transport device to being delivered using different kinds of transport devices;
   v. adding a delivery item (5) and/or a respective route for delivering the delivery item (5);
   vi. removing a delivery item (5) and/or respective route for delivering the delivery item (5);
   vii. swapping the time-wise ordering of two successive deliveries for a transport device;
   viii. adding to the route for delivering a delivery item (5) an intermediate stop at an energy station (19) for providing energy to the assigned transport devices to complete the delivery of the respective delivery item (5);
   ix. combining at least two routes for delivering at least two delivery items (5) into a single route.
M23. Method according to any of the 3 preceding embodiments, wherein step c. further comprises determining efficiency and constraint fulfilment of each generation (5100).
M24. Method according to the preceding embodiment, wherein the efficiency and constraint fulfilment of a generation (5100) is determined based on at least one of:
   i. distance travelled by the transport devices to deliver the plurality of delivery items (5);
   ii. time spent to deliver the plurality of delivery items (5);
   iii. energy consumed by the transport devices to deliver the plurality of delivery items (5);
   iv. number of transport devices required for delivering the plurality of delivery items (5);
   v. number of human employees that can be involved in the process of delivering the plurality of delivery items (5);
   vi. accordance with regulations or laws, such as, traffic laws;
   vii. cost of carrying out the delivery routing plan (15).
M25. Method according to any of the preceding method embodiments, wherein step c. is executed until a termination condition is fulfilled.
M26. Method according to the preceding embodiment, wherein the termination condition comprises a time limit specifying the maximum time that step c. is allowed to execute.
M27. Method according to any of the 2 preceding embodiments and with features of embodiment M23, wherein the termination condition comprises comparing the efficiency of a generation (5100) with a minimum required efficiency and terminating execution of step c. if the efficiency of a generation (5100) is not smaller than the minimum required efficiency.
M28. Method according to any of the preceding method embodiments and with features of embodiment M20, wherein in step c. at least one generation (5100), such as, the generation (5100) of the last iteration of step c. is taken into consideration to output the delivery plan (15).
M29. Method according to any of the preceding method embodiments and with the features of embodiments M20 and M23, wherein in step c. at least one generation (5100) providing the best efficiency is taken into consideration to output the delivery plan (15).
M30. Method according to any of the preceding method embodiments, wherein the method comprises performing or continuing to perform or repeating step c. during travel of the transport devices for delivering the plurality of delivery items.
M31. Method according to the preceding embodiment, wherein the routing plan can be changed during the travel of the transport devices for delivering the plurality of delivery items.

### Item Delivery

M32. Method according to any of the preceding method embodiments and with the features of embodiment M4, wherein the method further comprises delivering the plurality of delivery items (5) to the respective delivery locations (33) using at least one mobile robot (10).
M33. Method according to any of the preceding method embodiments and with the features of embodiment M4, wherein the method further comprises delivering the plurality of delivery items (5) to the respective delivery locations (33) using at least one transport apparatus (20).
M34. Method according to any of the preceding method embodiments and with the features of embodiment M4, wherein the method further comprises delivering the plurality of delivery items (5) to the respective delivery locations (33) using at least one mobile robot (10) and at least one transport apparatus (20).
M35. Method according to any of the preceding method embodiments and with the features of embodiment M4, wherein the method further comprises transferring at least one delivery item (5) from a transport apparatus (20) to a mobile robot (10).
M36. Method according to any of the preceding method embodiments and with the features of embodiment M4, wherein the method further comprises
   the transport apparatus (20) carrying at least one mobile robot (10), wherein the at least mobile robot (10) carry at least one delivery item (5); and
   the transport apparatus (20) transporting the at least one mobile robot (10) to an intermediate location; and
   unloading the at least one mobile robot (10) at the intermediate location; and
   the at least one mobile robot (10) transporting the at least one delivery item (5) to the respective delivery locations (33).

### Data Processing Device

M37. Method according to any of the preceding method embodiments, the method comprising executing step c. in a data processing device (40).
M38. Method according to the preceding embodiment, wherein the data processing device (40) is part of a server, such as, a cloud server.
M39. Method according to any of the preceding embodiments, wherein the method comprises executing step c. in a computing system (400), preferably in a cloud computing system (400).
M40. Method according to the preceding embodiment, wherein the computing system comprises the data processing device (40).
M41. Method according to any of the four preceding embodiments, wherein step b. comprises the data processing device (40) and/or the computing system (400) receiving the delivery location (33).
M42. Method according to any of five preceding embodiments, wherein step a. comprises the data processing device (40) and/or the computing system (400) receiving the locations of the delivery items (5).

### Computer Implemented Method

M43. Method according to any of the preceding method embodiments, wherein the method is a computer-implemented method.

### Delivery System

M44. Method according to any of the preceding method embodiments, wherein the method further comprises delivering the plurality of delivery items (5) using at least one delivery system (60).
M45. Method according to the preceding embodiments, wherein the delivery system (60) comprises at least one mobile robot (10).
M46. Method according to any of the 2 preceding embodiments, wherein the delivery system (60) comprises at least one transport apparatus (20).
M47. Method according to any of the 3 preceding embodiments, wherein the method comprises the delivery system (60) delivering the plurality of delivery items according to the routing plan (15).
M48. Method according to any of the four preceding embodiments, wherein the method comprises transmitting the routing plan (15) to the delivery system (60).
M49. Method according to any of the five preceding embodiments and with the features of embodiment M37, the method comprising the data processing device (40) transmitting the routing plan (15) to the delivery system (60).

### Controlling System

M50. Method according to any of the preceding embodiments, wherein the method comprises a controlling system (600) performing step a.
M51. Method according to the preceding embodiment, wherein the method comprises the controlling system (600) transmitting the location of delivery items (5) to a computing system (400) and/or to a data processing device (40).
M52. Method according to any of the preceding embodiments, wherein the method comprises a controlling system (600) performing step b.
M53. Method according to the preceding embodiment, wherein the method comprises the controlling system (600) transmitting the delivery locations (33) to a computing system (400) and/or to a data processing device (40).
M54. Method according to any of the preceding embodiments, wherein the method comprises a controlling system (600) transmitting at least one delivery request (31) to a computing system (400) and/or to a data processing device (40).
M55. Method according to any of the preceding embodiments, wherein the method comprises a controlling system (600) transmitting logistics data (61) to a computing system (400) and/or to a data processing device (40).
M56. Method according to any of the preceding embodiments, wherein the method further comprises a controlling system (600) receiving at least one request for item delivery (31) from at least one user terminal (300).
M57. Method according to any of the preceding embodiments, wherein the method further comprises at least one user generating with a corresponding user terminal (300) at least one request for item delivery (31).
M58. Method according to the preceding embodiment, the method comprising the user terminal (300) transmitting the at least one delivery request (31) to a controlling system (600).
M59. Method according to any of the three preceding embodiments, wherein the method comprises the user terminal (300) transmitting the at least one delivery request (31) to the computing system (400) and/or to a data processing device (40).

Below, system embodiments will be discussed. These embodiments are abbreviated by the letter “S” followed by a number. Whenever reference is herein made to “system embodiments”, these embodiments are meant.
S1. Routing system for routing a plurality of delivery items to a plurality of delivery locations by a plurality of transport devices, comprising
   a. a controlling system (600) configured for localizing the delivery items (5) and localizing the delivery locations (33); and
   b. a computing system (400) configured to execute at least one genetic algorithm (50) for at least one of:
      i. assigning the transport devices to the delivery items (5); and
      ii. assigning the transport devices to times of delivery (35); and
      iii. routing the transport devices to the delivery locations (33).
   c. wherein the controlling system (600) is configured to control the transport devices according to the output of the computing system (400).
S2. Routing system according to the preceding embodiment, wherein the controlling system (600) is configured to determine a respective time of delivery (35) or a respective time window of delivery (35) for at least one of the plurality of delivery items (5).

### Transport Devices

S3. Routing system according to any of the preceding system embodiments, wherein the routing system comprises different kinds of transport devices, the difference concerning at least one of:
   i. the sizes of the transport devices;
   ii. the number of delivery items the transport devices transport;
   iii. the size of delivery items the transport devices transport;
   iv. the way of travel they are configured to use.
S4. Routing system according to the preceding embodiment, wherein the routing system comprises a first transport device (10) and a second transport device (20), wherein
   i. the first transport device (10) is a mobile robot (10); and
   ii. the second transport device (20) is a transport apparatus (20); and
   iii. the transport apparatus (20) is configured to at least one of:
      comprise a bigger carrying capacity than the mobile robot (10), and
      transport one or more mobile robots (10).
S5. Routing system according to the preceding embodiment, wherein the mobile robot (10) is configured to carry at least one delivery item (5), preferably up to 10 delivery items (5).
S6. Routing system according to any of the 2 preceding embodiments, wherein the mobile robot (10) is configured as a fully- or nearly-autonomous mobile robot (10).
S7. Routing system according to any of the 3 preceding embodiments, wherein the mobile robot (10) is configured to travel in public roads, driveways, bike lanes and sidewalks.
S8. Routing system according to any of the 4 preceding embodiments, wherein the mobile robot (10) is configured to travel at low speeds, such as, 0-30 km/h, or no more than 8 km/h, or no more than 6 km/h.
S9. Routing system according to any of the 5 preceding embodiments, wherein the transport apparatus (20) is configured to carry at least one delivery item (5), preferably up to 200 delivery items (5).
S10. Routing system according to any of the 6 preceding embodiments, wherein the transport apparatus (20) is configured to carry at least one mobile robot (10), preferably at most 30 mobile robots (10), more preferably at most 20 mobile robots (10).
S11. Routing system according to any of the 7 preceding embodiments, wherein the transport apparatus (20) is configured to travel in public roads.
S12. Routing system according to any of the 8 preceding embodiments, wherein the transport apparatus (20) is configured to travel at low and high speeds, such as 0-150 km/h.

### Item Loading Location

S13. Routing system according to any of the preceding system embodiments, wherein the routing system comprises an item loading location (1) wherein delivery items (5) are loaded to at least one transport device.
S14. Routing system according to the preceding embodiment, wherein the item loading location (1) is an item storage facility configured to store the plurality of delivery items (5).
S15. Routing system according to any of the 2 preceding embodiments, wherein the item loading location (1) is a facility configured to offer, such as sell, delivery items (5).

### Request for Item Delivery

S16. Routing system according to any of the preceding system embodiments, wherein the controlling system (600) is configured to receive at least one request for item delivery (31) from at least one user (30) and the request for item delivery (31) comprises a location attribute (33) wherein the at least one user (30) specifies a preferred location for receiving the delivery item (5).
S17. Routing system according to the preceding embodiment, wherein the request for item delivery (31) comprises a time attribute (35) wherein the at least one user (30) specifies a preferred time or time window for receiving the delivery item (5).
S18. Routing system according to any of the 2 preceding embodiments, wherein the routing system further comprises a user terminal (300) configured to facilitate the user (30) to provide a request for item delivery (31) to the controlling system (600).
S19. Routing system according to the preceding embodiment, wherein the controlling system (400) and the user terminal (300) are configured for remote data transmission between each-other.

### Delivery Plan

S20. Routing system according to any of the preceding system embodiments, wherein the computing system (400) comprises a data processing device (40).
S21. Routing system according to any of the preceding system embodiments, wherein the computing system (400) is a server, such as, a cloud server.
S22. Routing system according to any of the preceding system embodiments, wherein the computing system (400) is configured to receive logistic data (61) and delivery request data (31) wherein
   the logistic data (61) comprises data related to the transport devices, such as, a list of transport devices and
   the delivery request data (31) comprises data related to the delivery items (5) and delivery locations (33).
S23. Routing system according to any of the preceding system embodiments, wherein the computing system (400) is configured to output a delivery plan (15).
S24. Routing system according to the preceding system embodiment, wherein the delivery plan (15) comprises for each delivery item (5) a respective delivery location (33), a respective time of delivery (35), assigned transport devices for delivering the delivery item (5) and assigned route for delivering the delivery item (5).
S25. Routing system according to any of the 2 preceding system embodiments, wherein the controlling system (600) is configured to receive the delivery plan (15) that is output by the computing system (400).
S26. Routing system according to the preceding system embodiment, wherein the computing system (400) and the controlling system (600) are configured for remote data transmission between each-other.

### Item Delivery

S27. Routing system according to any of the preceding system embodiments, wherein at least one transport device is fully-autonomous and the controlling system (600) provides the assigned delivery tasks by the computing system (400) to the at least one fully-autonomous transport device and the at least one fully-autonomous transport device autonomously completes the assigned delivery task according to the output of the computing system (400).
S28. Routing system according to any of the preceding system embodiments, wherein at least one transport device is nearly-autonomous and the controlling system (600) provides the assigned delivery tasks by the computing system (400) to the at least one nearly-autonomous transport device and the at least one nearly-autonomous transport device assisted by the controlling system (600) completes the delivery task according to the output of the computing system (400).
S29. Routing system according to the preceding system embodiment, wherein the controlling system (600) comprises a remote controller configured to facilitate a human operator to remotely assist at least one nearly-autonomous transport device.

Below, use embodiments will be discussed. These embodiments are abbreviated by the letter “U” followed by a number. Whenever reference is herein made to “use embodiments”, these embodiments are meant.
U1. Use of the system according to any of the preceding system embodiments for carrying out the method according to any of the preceding method embodiments.
U2. Use of the system according to any of the preceding system embodiments and method according to any of the preceding method embodiments for delivering a plurality of items, preferably for performing last-mile delivery.
U3. Use of the system according to any of the preceding system embodiments and method according to any of the preceding method embodiments for delivering a plurality of items in a campus, preferably a college and/or university campus.

### BRIEF DESCRIPTION OF THE FIGURES

FIGS. 1A to 1D depict different embodiments of an item delivery systems;

FIG. 2 provides a flowchart describing a method for delivering items;

FIG. 3 depicts a schematic of a data processing device configured to compute a delivery routing plan and different schematic representations of a delivery routing plan;

FIG. 4A depicts a flowchart describing an adapted genetic routing algorithm configured to optimize a delivery routing plan;

FIG. 4B demonstrates elements and operations used by the adapted genetic routing algorithm;

FIG. 5A demonstrates the execution of a delivery routing plan by a single mobile robot;

FIG. 5B demonstrates the execution of a delivery routing plan using a first transport device and second transport device;

FIG. 6 depicts a system configured for receiving delivery requests, computing a delivery plan to complete the delivery requests and carrying out the delivery process.

### DETAILED DESCRIPTION OF THE FIGURES

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, time delays between steps can be present between some or all of the described steps.

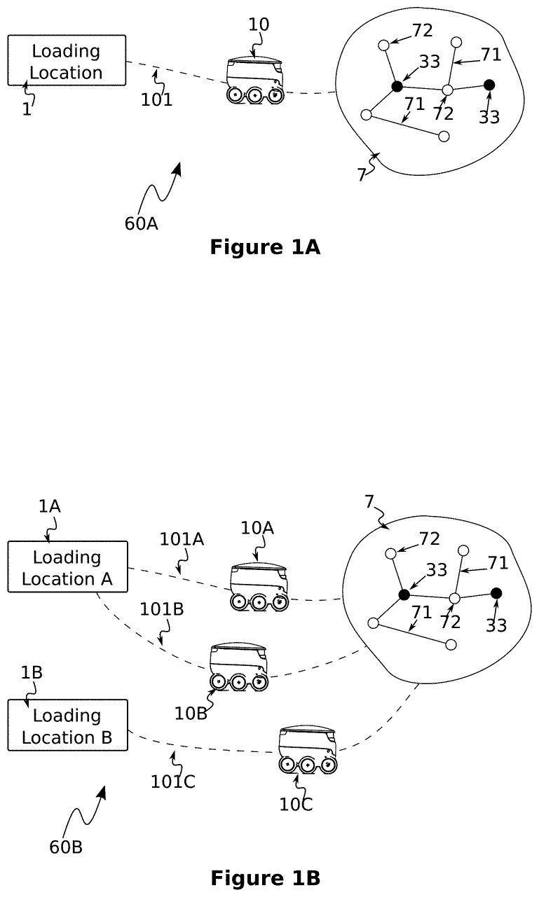

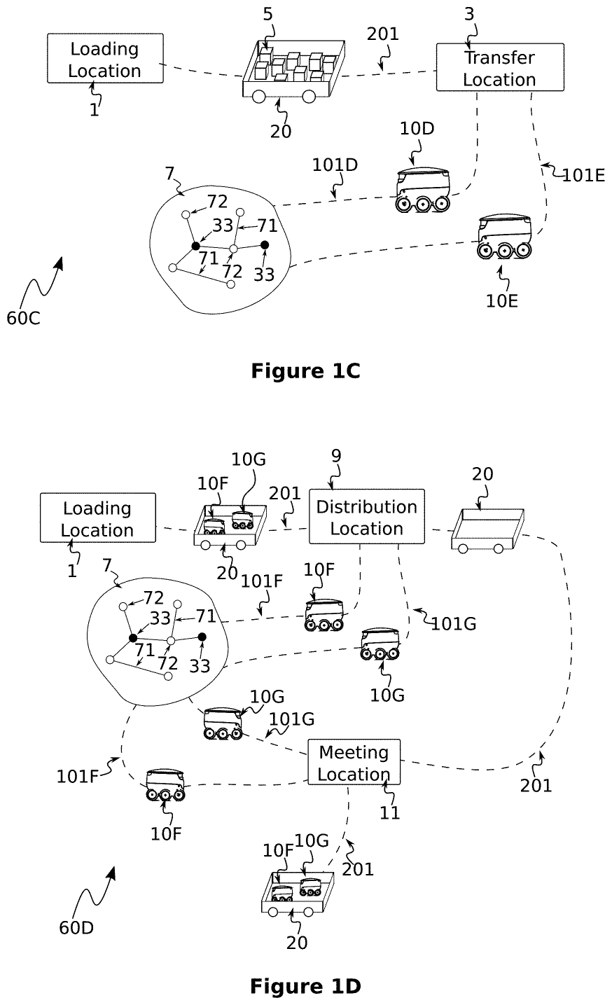

FIG. 1A depicts a system that can be configured for item delivery, such as, for last-mile item delivery. Last-mile delivery usually refers to the last leg of the delivery of the goods or items from a storage location to the final delivery destination, i.e. to the recipient, end-user.

That is, FIG. 1A depicts an embodiment of a delivery system 60, referred herein with the referral 60A. The delivery system 60A can comprise a loading location 1, a mobile robot 10 and a delivery area 7. The loading location 1, or item loading location 1 can be the location wherein the items to be delivered can be loaded in the mobile robot 10. The loading location 1 can be a storage facility wherein a plurality of packages or items, originating from different locations, can be stored before being delivered to the respective recipients. The loading location 1 may also be a facility or building offering items or goods that can be ordered or bought by the recipient, such as, shops or restaurants. For example, the recipient can order or buy items in a facility which can be located in the loading location 1 and the ordered items can be delivered to the recipient in a delivery location, which delivery location can be positioned in the delivery area 7. In yet another example, the item loading location may be a cafeteria, restaurant or shop in a university campus.

The mobile robot 10 can be an autonomous or nearly-autonomous robot 10 or any of the 6 automation levels, preferably levels 1 to 5, as defined by the Society of Automotive Engineers (SAE) in J3016 Autonomy Levels. In some embodiments, the mobile robot 10 can be a fully autonomous mobile robot 10 (i.e. level 5 according to SAE). That is, the fully autonomous mobile robot 10 can navigate, drive and execute other functionalities related to its operation on its own without a human operator controlling it. In some embodiments, the mobile robot 10 can be nearly- or semi-autonomous (e.g. any of levels 1 to 4 according to SAE). That is, the nearly autonomous mobile robot 10 can in some instance and/or for some functionalities operate on its own and in some other instance and/or other functionalities be assisted by a human operator.

The mobile robot 10 can be configured for storing and delivering items. For example, the mobile robot 10 can comprise a body or housing comprising a compartment adapted to house or store items to be delivered. The body may comprise an opening on one of its sides or on a part of one of its side, such as, on the top side. Said opening may allow for the insertion of goods, items and packages in the compartment of the body. The opening of the compartment may be covered by a lid. Said lid, may assume an opened or closed position. The lid in the closed position cannot allow access in the inside of the compartment, hence the items cannot be accessed when the lid is in a closed position. The lid of the compartment in the open position may allow access to the inner of the compartment through the opening of the body and hence, the items that may be positioned there can be accessed. For example, this can allow the recipient to reach for the item(s). The lid can be locked (unlocked) to (from) the body of the mobile robot 10. That is, the lid can be locked in the closed position and hence cannot be opened without causing damage to the structure of the mobile robot. The lid can be unlocked which can allow the positioning of the lid from the closed to the opened position.

The mobile robot 10 can be configured to drive generally on the sidewalks. Hence the mobile robot can be configured to drive at low speeds, such as 0-30 km/h, or no more than 8 km/h, or no more than 6 km/h.

In some embodiments, the mobile robot 10 may comprise at least one battery which provides energy to the mobile robot 10 that can be used for moving and internal operations of the mobile robot 10. Nevertheless, the mobile robot may in addition or alternatively be fuel-powered or hybrid—i.e. battery and fuel powered.

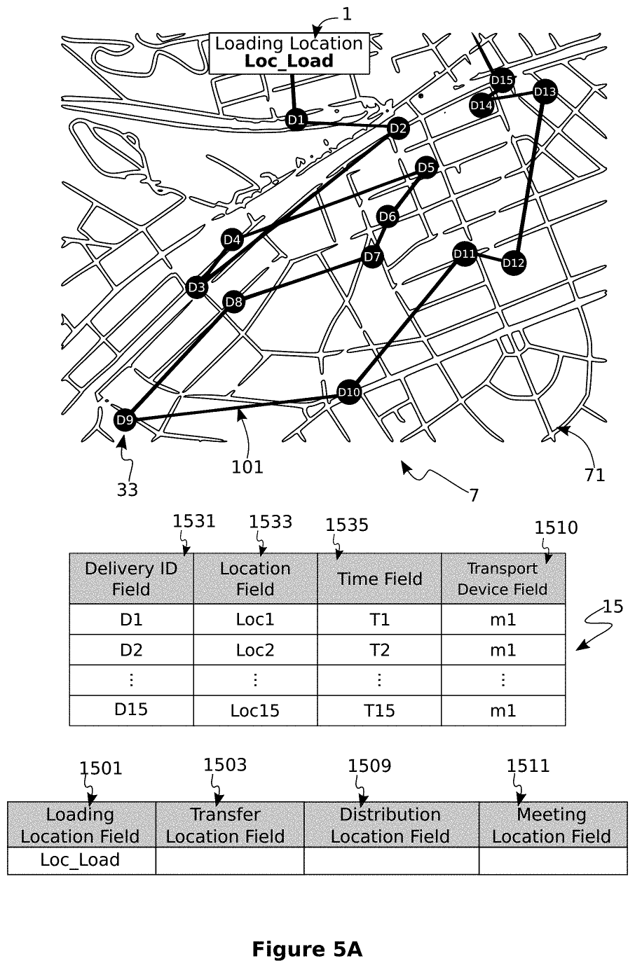

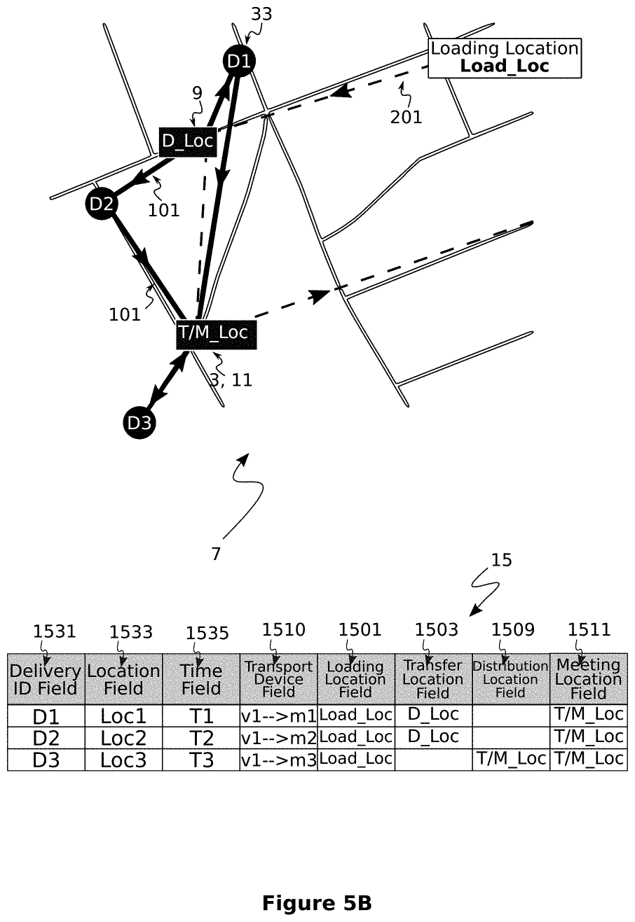

The delivery area 7 can be an inhabited area or region 7, such as, a neighbourhood, city, town, suburb area. The delivery area 7 may also be a predefined area or part of a neighbourhood, city, town, state or suburb area, which parts can, for example, be defined by the logistics of the item delivery process. The delivery area 7 can comprise a network of streets 71 and buildings 72. Said network of streets 71 and buildings 72 can be labelled to facilitate distinction between them and navigation. For example, the streets 71 may be labelled with a name of the street and the buildings 72 with the name of the street from which they can be accessed and a number. It can be advantageous, that within the delivery area 7 the labels of the buildings 72 and/or the streets 71 are unique. Examples of the delivery area 7 are provided in FIGS. 5A and 5B. The delivery area 7 can also be or comprise a campus (such as a college and/or a university campus) comprising buildings, coffee shops, restaurants, shops, sidewalks, footpaths, bicycle lanes, vehicle paths or streets, driveways, parking lots, etc.

The delivery area 7 comprises at least one delivery location 33 wherein item(s) are to be delivered. Said delivery locations 33 can be specified by the recipient, for example, while ordering the respective items. The mobile robot 10 can transfer (i.e. transport, deliver) such items from the loading location 1 to the respective item delivery locations 33 within the delivery area 7. The mobile robot 10 can follow a trajectory 101 during the delivery of the item(s) to approach the delivery area 7 and the delivery location(s) 33.

For example, the recipient may be a student, a member of a faculty and/or an employee in a (preferably university) campus. The delivery location 33 may be a building in a campus and can comprise the address of the building (e.g. a name of a street, a number of a building, name of a building, label assigned to a building).

In addition, the delivery location 33 may comprise an entrance number. This is particularly advantageous for buildings with multiple entrances/exits.

Alternatively or additionally, the delivery location 33 may comprise coordinates (e.g. GPS coordinates). The coordinates may be automatically acquired when a recipient orders an item. The coordinates may be further adjusted or provided by the recipient during the order and/or while waiting for the delivery. The delivery location 33 comprising coordinates can be particularly advantageous for recipients in a remote location, such as an urban open space. The delivery location 33 comprising coordinates can be advantageous for recipients in a university campus, wherein generally a public address system is missing (e.g. street name and number) and the recipients may be positioned in open spaces, such as, yard, park, etc.

The trajectory 101, for illustration purposes, is symbolically depicted in FIG. 1A with a dashed line 101 joining the loading location 1 and the delivery area 7. Though not depicted in the schematic, the trajectory of the mobile robot 101 can continue on the delivery area 7, preferably unit the delivery location 33 is reached. Furthermore, the buildings 72 are represented with blank circles and the delivery locations 33 with filled circles. The buildings 72 and delivery locations 33 are interconnected by the network of streets 71, depicted with lines 71.

In FIG. 1A the delivery system 60A has been described with reference to a single mobile robot 10 and a single loading location 1. However, the present technology may also employ a plurality of mobile robots 10 and/or a plurality of loading locations 1 and/or a plurality of delivery areas 7. An example of such a system is provided in FIG. 1B.

The loading location 1, trajectory 101 and the delivery area 7 can be generally referred to as an outdoor setting. The outdoor setting can for example be or comprise a campus such as a college and/or university campus (and/or a company campus).

FIG. 1B depicts a further embodiment of a delivery system 60, referred herein with referral 60B. The delivery system 60B comprises two loading locations 1A, 1B and three mobile robots 10A, 10B and 10C. The mobile robots 10A and 10B can transport item(s) from the loading location 1A to the item(s) respective delivery locations 33 within the delivery area 7, following their respective trajectories 101A and 101B, as depicted. The mobile robot 10C can transport item(s) from the loading location 1B to the item(s) respective delivery location within the delivery area 7, following its respective path or trajectory 101C, as depicted.

In other words, in the system 60B of FIG. 1B a plurality or a fleet of mobile robots 10 are provided and can be used for item delivery. Additionally, the items to be delivered can be stored in a plurality of item loading locations 1. The fleet of mobile robots 1 can be configured to receive the items stored in a plurality of loading locations 1 and deliver them to the respective delivery locations 33.

FIG. 1C depicts a further embodiment of a delivery system 60, herein referred with the numeral 60C, that can be configured for multimodal item delivery. That is, the item delivery can be performed by using a combination of mobile delivery robots and at least one other transport apparatus rather than the mobile delivery robots. Each delivery may be performed by a single vehicle, or a combination of vehicles (one vehicle transporting the item to an intermediate point, where it is handed over to another vehicle that then completes the final leg of delivery).

The delivery system 60C, similar to systems 60A and 60B, comprises at least one item loading location 1 (in FIG. 1C only one loading location 1 is depicted), at least one mobile robot 10 (in FIG. 1C two mobile robots 10D and 10E are depicted) and a delivery area 7.

In addition, the delivery system 60C comprises a second transport device, such as the transport apparatus 20, and a transfer location 3. In general, the delivery system 60C can comprise at least one transport apparatus 20 and at least one transfer location 3.

The transport apparatus 20, can be an autonomous or nearly autonomous vehicle 20, such as, a vehicle 20. The transport apparatus 20 can be configured to carry at least one item 5. For example, the transport apparatus 20 can comprise an enclosed compartment with an opening for inserting or receiving items. The compartment and the opening of the compartment can be secured such that only intended or authorized persons can access the inner part of the compartment, more particularly, the items 5 comprised in the compartment. Further, the transport apparatus 20 can be configured to transport the at least one item 5 from the loading location 1 to the transfer location 3, following a trajectory or path 201.

In general, the transport apparatus 20 can be configured to have a bigger capacity (i.e. carry more items 5) compared to the mobile robots 10. For example, the mobile robot 10 can have a capacity of at most 10 items or of at most 5 items and the transport apparatus 20 a generally higher capacity such as, of at most 200 items or at most 100 items. Furthermore, the transport apparatus 20 can be configured to travel at higher speeds compared to the mobile robot 10. Further still, the transport apparatus 20 can be configured to travel on traffic roads.

In a transfer location 3, the items 5 can be transferred from one or more transport apparatus(es) 20 to one or more mobile robots 10. For example, as depicted in FIG. 1C, the items 5 can be transferred from one transport apparatus 20 to two mobile robots 10D and 10E.

The transfer of items 5 from the transport apparatus 20 to the mobile robots 10 can be done manually, for example, a human operator can transfer the packages 5 by carrying them or using a carrying device and displacing the items 5 from the transport apparatus 20 to the mobile robot 10. For example, the transfer of items 5 can be done by a driver or operator of the transport apparatus 20 and/or an operator of the mobile robot 10.

However, the transfer of items 5 can also be executed in an automatic or nearly-automatic manner, wherein the transport apparatus 20 and/or the mobile robot 10 and/or a third apparatus can be configured to carry and displace the items from the transport apparatus 20 to the mobile robot 10. For example, the transfer of items 5 can be conducted by automatic guided vehicles (not shown) that can be autonomous or nearly-autonomous. In such scenarios, the transfer location may be configured to facilitate such process, for example, may be equipped with distinguishable lines on the floor configured to guide the automated guided vehicles.

Having received the items 5, the mobile robot 10 can deliver them in their respective delivery locations 33 in the delivery area 7.

The delivery system 60C can be particularly advantageous for delivering a plurality of items to a plurality of closely positioned locations, such as within a neighbourhood or within a university campus. The transport apparatus 20 can deliver (i.e. approach) the items to the delivery area 7, such as, a neighbourhood or university campus. That is, the transfer location 3 can be near or in (e.g. at the entrance or at a central position) of the delivery area 7. One or more mobile robot 20 can then transport the items to the respective delivery locations within the delivery area 7. This can further be particularly advantageous when the delivery area 7 is within (or comprises) a university campus wherein the entrance of large vehicles (e.g. transport apparatus 20) may be prohibited, not possible or associated with procedures for granting access. In such cases, the transport apparatus 20 may bring one or more items (preferably a plurality of items) close to the university campus (e.g. at an entrance of a campus) and the mobile robot(s) 20 can deliver the items to the respective recipients in the campus. Due to their smaller size, the mobile robots 20 can better manoeuvre within the campus (resulting in a fast item delivery) and can approach closer to the recipient.

FIG. 1D depicts yet another embodiment of the delivery system 60, referred herein with the referral 60D. System 60D can be configured for multimodal item delivery. That is, more than one type of delivery or transportation device can be used for delivering items to their respective recipients. More specifically, the delivery of the items can be carried out by the use of at least one mobile robot 10 and at least one transport apparatus 20.

The mobile delivery robots 10 can be configured (as discussed in FIG. 1A) to carry at least one item 5. The mobile delivery robots 10 can be loaded with items 5 at a loading location 1. The transport apparatus 20 can be configured to carry at least one mobile robot 10. The transport apparatus 20 can be loaded with at least one mobile robot 10 at the loading location 1.

In one embodiment, the mobile robot 10 can be loaded with at least one item 5 in the loading location 1 or can be loaded with at least one item 5 prior to the mobile robot 10 arriving at the loading location 1. After the mobile robots 5 are loaded with at least one item 5 they can be loaded in the transport apparatus 20. For example, the mobile robots 10 can drive in a compartment of the transport apparatus 20 configured to carry at least one mobile robot 10. It can be understood that not more than the maximum mobile robot carrying capacity of the transport apparatus 20, can be loaded in the transport apparatus 20. For example, the transport apparatus 20 can carry at least 1 and at most 50 mobile robots, preferably at least 3 and at most 30 mobile robots. In other words, in some embodiments, the mobile robots 10 can be loaded with items to be delivered, prior to the mobile robots 10 entering or being loaded to the transport apparatus 20.

However, in some embodiments, the transport apparatus 20 can be configured to carry at least one item 5. Additionally, the transport apparatus can be configured to carry at least one mobile robot 10. The transport apparatus 20 can be loaded with at least one item prior and/or after and/or while the mobile robots 10 enter or are being loaded to the transport apparatus. Further, the items can be loaded to the mobile robots 10 while the mobile robots 10 are inside the transport apparatus. For example, the transport apparatus 20 can be loaded with at least one item at the item loading location. After that, at least one mobile robot 10 can enter the transport apparatus 20. Then, the items can be loaded from the transport apparatus 20 to the at least one mobile robot 10 within the transport apparatus 20.

The transport apparatus 20 carrying the mobile robot(s) 10 and the items to be delivered 5 can drive to a distribution location. In the distribution location, the mobile robots 10 can exit or can be unloaded from the transport apparatus 20. The mobile robots 10, which can already be loaded with items to be delivered, can proceed by delivering the items to their respective destinations 33 within the delivery area 7. For example, as depicted in FIG. 1D, the mobile robots 10F and 10G follow the respective trajectories 101F and 101G to approach the delivery area 7 and deliver the items. After finishing the delivery of the items, i.e. after having delivered or attempted to deliver all the scheduled items, the mobile robots 10 approach a meeting location 11.

In the meantime, the transport apparatus 20 after having distributed the mobile robot 10 in the distribution location 9, can drive toward the meeting location 11.

In the meeting location 11, the mobile robots 10 and the transport apparatus 20 can “meet”. That is, in the meeting location 11 the mobile robot(s) 10 can be loaded back to the transport apparatus 20. The transport apparatus 20 may drive back to the loading location 1.

In other words, generally referring to FIGS. 1A to 1D, different delivery system 60 embodiments are depicted. In some embodiments, such as the delivery systems 60A and 60B depicted respectively in FIGS. 1A and 1B, delivery system embodiments comprising one type of transport device is depicted. Said type of transport device, which can be referred as a first transport device 10 can be realized with at least one mobile robot 10. However, in some other embodiments of the delivery system 60, such as, the delivery systems 60C and 60D depicted respectively in FIGS. 1C and 1D the delivery system can comprise multiple types of transport devices. More specifically, the delivery systems 60C and 60D can comprise a first transport device 10, which can be realized with at least one mobile robot 10, and a second transport device 20, which can be realized with at least one transport apparatus 20, such as, a vehicle 20.

The first and the second item transport devices 10 and 20 can be configured in different manners. For example, in some embodiments, the transport apparatus 20 can be configured to comprise at least one item, preferably a plurality of items. More preferably, the transport apparatus 20 can be configured to comprise an item carrying capacity larger than the mobile robot 10. This can allow the transport apparatus 20 to transfer at least one item to at least one mobile robot 10, preferably to a plurality of mobile robots 10, which mobile robot(s) 10 can deliver the items to the respective delivery locations 33.

In another delivery system configuration, the transport apparatus can be configured to carry at least one mobile robot 10, preferably a plurality of mobile robots 10, which it can distribute at a distribution location 9 to reach and deliver the at least one item that the mobile robots 10 can comprise to the respective delivery location 33.

In yet some other embodiments, the transport apparatus 20 can be configured to carry at least one item and at least one mobile robot 10. Thus, the transport apparatus 20 can distribute the mobile robot(s) 10 it can carry at a distribution location for the robot(s) 10 to deliver the items the robot(s) 10 can carry to their respective delivery locations 33. In addition, the transport apparatus can “meet” at least one mobile robot 10 (which can be from the mobile robot(s) previously distributed) at a transfer location 3 for the items to be transferred from the transport apparatus 20 to the mobile robot 10.

Thus, generally the transport apparatus 20 can comprise bigger dimensions compared to the mobile robot 10. In different words, the second transport device 20 can generally comprise bigger dimensions compared to the mobile robot 10. Put differently still, the second transport device 20 (i.e. transport apparatus 20) can comprise a carrying capacity bigger than the carrying capacity of the first transport device 10 (i.e. mobile robot 10), such that, the second transport device 20 can carry more items and/or mobile robots 10 compared to the mobile robot 10.

In any of the above-mentioned embodiments of the delivery system 60, when the second transport device 20 can be configured to carry at least one item, can be configured to deliver at least one of the items directly to the delivery location 33. However, when referring to systems configured for multimodal delivery, at least one item can be delivered such that it is carried by at least two vehicles during the delivery process. For example, system 60A and 60B are not multimodal delivery systems, while systems 60C and 60D are multimodal delivery systems.

The delivery system 60D can be particularly advantageous for delivering a plurality of items to a plurality of closely positioned locations, such as within a neighbourhood or within a university campus. The transport apparatus 20 can deliver (i.e. approach) the mobile robots 20 to the delivery area 7, such as a neighbourhood or university campus. That is, the distribution location 9 can be near or in (e.g. at the entrance or at a central position) of the delivery area 7. One or more mobile robot(s) 20 can, after unloading from the transport apparatus 20, transport the items to the respective delivery locations within the delivery area 7. This can further be particularly advantageous when the delivery area 7 is within (or comprises) a university/college/work/company campus wherein the entrance of large vehicles (e.g. transport apparatus 20) may be prohibited, not possible or associated with procedures for granting access. In such cases, the transport apparatus 20 may approach one or more mobile robot(s) 20 (preferably a plurality of items) to the campus (e.g. at an entrance of a campus) and the mobile robot(s) 20 can deliver the items to the respective recipients in the campus. Due to their smaller size, the mobile robots 20 can better manoeuvre within the campus (resulting in a fast item delivery) and can approach closer to the recipient.

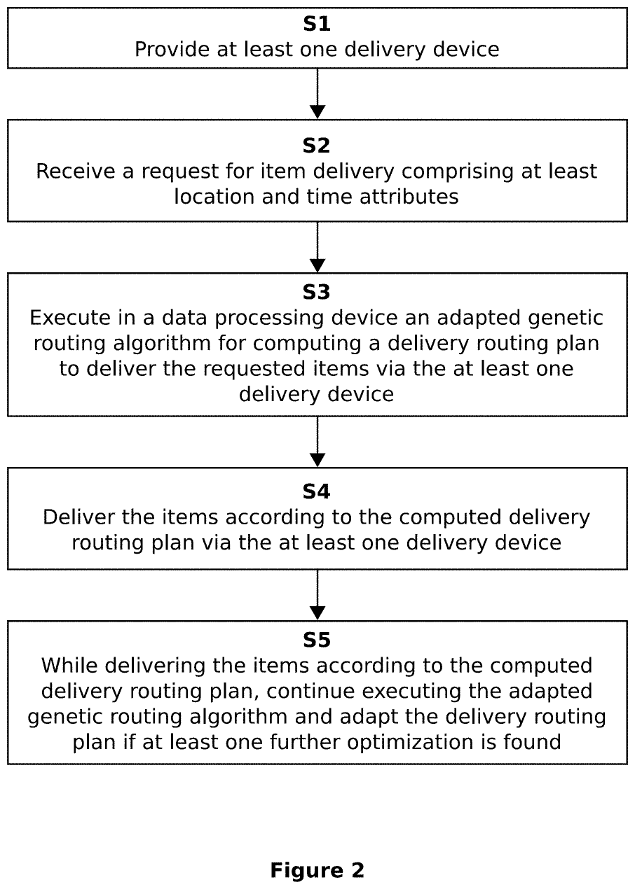

FIG. 2 depicts a flowchart of a method configured for delivering items. The method depicted in FIG. 2 can be used in conjunction with any of the delivery system 60 embodiments depicted in FIGS. 1A to 1D. That is, the delivery system 60 can be configured for carrying out the item deliveries based on the method for delivering items illustrated in FIG. 2.

In a step S1, the method can comprise providing at least one device for item delivery. In some embodiments, one device for item delivery can be provided, such as, at least one mobile robot 10. In some other embodiments, two devices for item delivery can be provided, such as, at least one mobile robot 10 and at least one transport apparatus 20. The mobile robot 10 and the transport apparatus 20 can be configured as discussed in the description of FIGS. 1A to 1D.

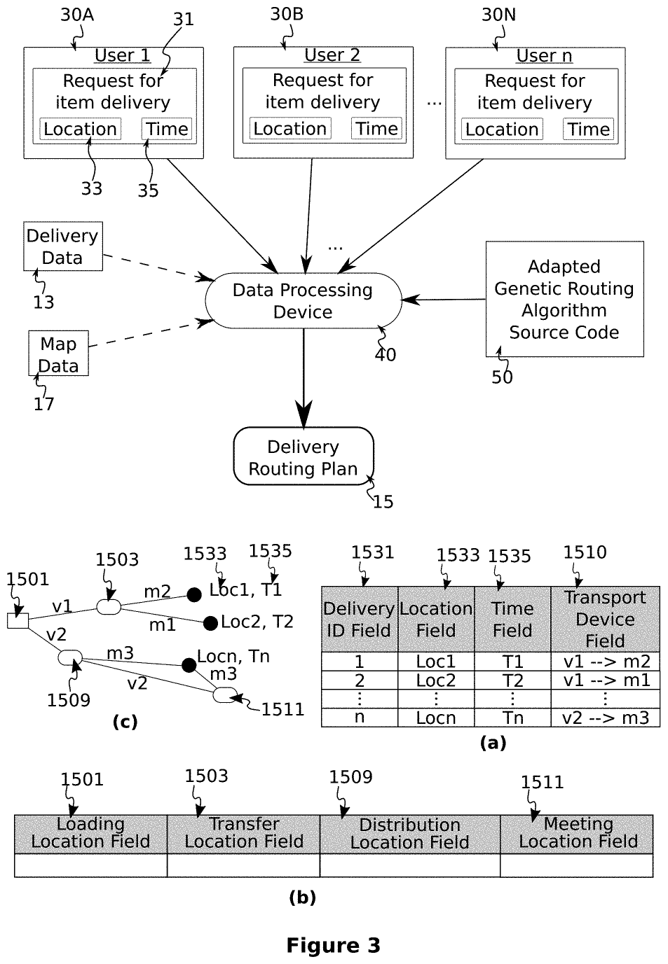

In a step S2, the method can comprise receiving a request for item delivery. The request for item delivery can be provided by a user, also referent as a recipient. However, it will be understood that a user may order an item to be received by a recipient other than himself. For example, the request can be made while a user orders or buys an item (e.g. through online shopping or online ordering) or when a user requests for an item to be delivered to a desired location. Hence, the request for item delivery can comprise a location attribute that can provide information regarding the location where the requested item is to be delivered. Additionally, the request for item delivery can comprise a time attribute that can provide a time or a time window when the user prefers an item to be delivered to the specified location. In other words, a user or recipient can request an item and can specify a time (or time window) and a location when and where the item is to be delivered. Further details are provided in FIG. 3.

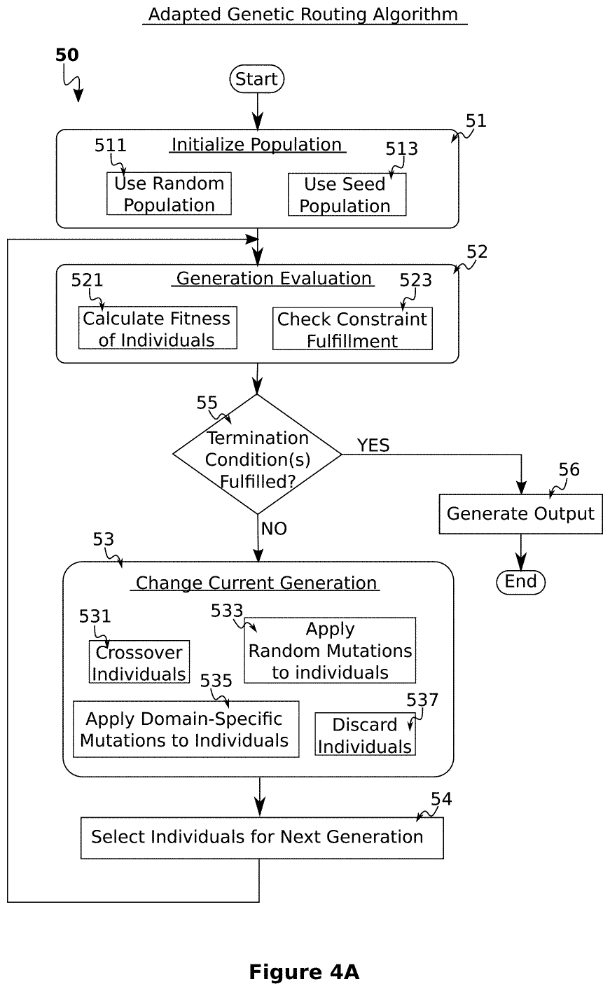

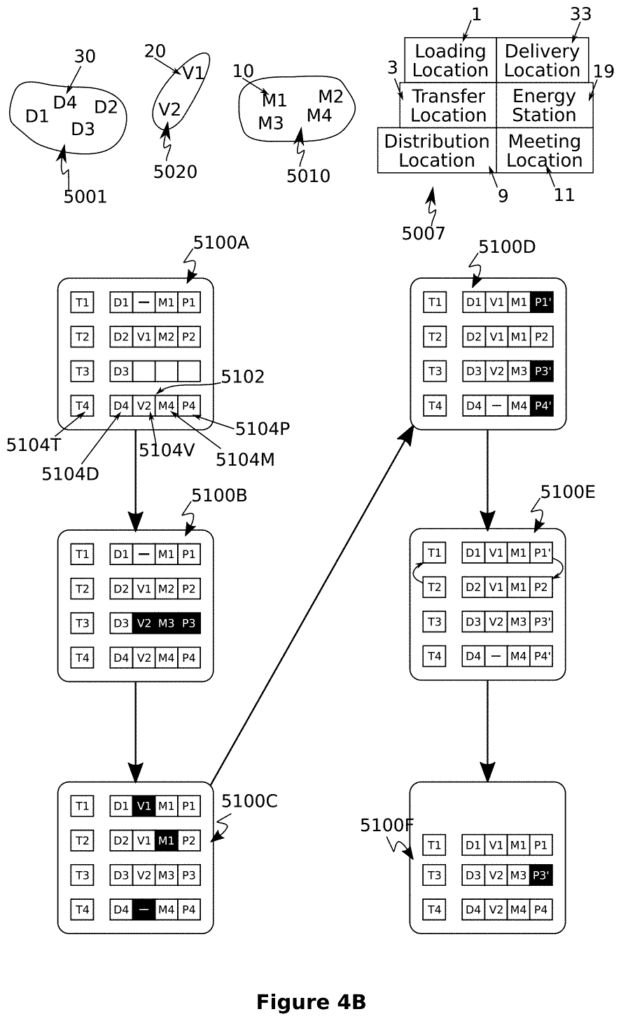

In a step S3, the method can comprise executing in a data processing device an adapted genetic routing algorithm for computing a delivery routing plan to deliver the requested items via the at least one device for item delivery. The adapted genetic routing algorithm, as will become apparent in the description of following FIGS. 3 and 4A, can be configured to find and optimize a route (i.e. determine an optimal or nearly-optimal route) for delivering a plurality of items in a plurality of locations using one or more devices for item deliveries. The optimization of the route can be done under at least one constraint, such as, the delivery locations of the items, time or time windows when items can be requested to be delivered, possible routes or streets that can be traversed in a delivery area, available energy in the item transport devices (mobile robot 10 and/or transport apparatus 20) that are used and/or number of delivery jobs that should be completed. A further constraint for optimizing the delivery route may be a condition that the robot 10 and/or the transport apparatus 20 must not run out of energy. For example, the battery comprised by a battery powered mobile robot 10 must not become empty during the delivery.

Further constraint(s) for optimizing the delivery route may depend on the item to be delivered, an item category and/or item loading location. For example, for the delivery of foods and/or drinks a further constraint may relate to the state of the foods and/or drinks to be delivered, such as, a coffee or meal must not arrive cold at the recipient.

In yet another example, a further constraint may relate to the time that the delivery device, generally the robot 10, arrives at the item loading location 1. That is, upon receiving a delivery request, a robot 10 may travel from an initial location (e.g. a parking lot or garage) to the item loading location 1 and from there on deliver the item (as discussed with respect to FIGS. 1A and 1B). Alternatively, upon receiving a delivery request, a transport apparatus 20 may travel from an initial location (e.g. a parking lot or garage) to the item loading location 1 and from there on deliver the item (as discussed with respect to FIGS. 1C and 1D). In such embodiments, it can be advantageous that the delivery device arrives at the item loading location at (approximately/substantially) the exact time when the delivery is ready, more particularly, a short amount of time before the delivery item is ready to be loaded on the delivery device. This is particularly advantageous for food and/or drink deliveries. That is, the moment the food and/or drink is prepared and is ready for delivery, the delivery device can arrive at the item loading location (in this case, a restaurant or bar). This step may further comprise generating hypothesis or predictions when the delivery item is ready to be loaded into the delivery device.

The objective of optimization of the routes can be any of the following: minimizing cost of delivery process, minimizing length of the routes traversed during the delivery process, minimizing time required to complete the delivery processes, minimizing delay of delivery of items, maximizing number of items that can be delivered, minimizing number of item transport devices (mobile robots 10 and/or transport apparatus 20) required, minimizing the energy needed for driving the robots and/or the transport devices, minimizing the time between the instant the item is ready to be loaded into the delivery device and the instant the delivery device is present at the item loading location, minimizing the waiting time of the delivery device at the item loading location for items to be loaded, ensuring that none of the utilized delivery devices run out of energy, ensuring only delivery devices with available energy more than the required energy for performing the delivery are selected (e.g. ensuring that only mobile robots with enough charge on their batteries are selected) and/or maximizing the range of the robot(s) and/or transport devices per load.

In some embodiments, step S3 can be carried out after step S2, i.e. S2 and S3 are executed sequentially. That is, only after all the expected delivery requests or only after a predetermined maximum number of delivery requests can be received in step S2, execution of the adapted genetic routing algorithm in step S3 can initiate.

However, in some other embodiments, execution of steps S2 and S3 can be parallelized. That is, while requests for item deliveries are being received in step S2, the adapted genetic routing algorithm in step S3 can be executed. The latter embodiments, may generate a delivery routing plan faster compared to the case when steps S2 and S3 are run sequentially. For example, when at least two delivery requests are received (it can be apparent that when one request is received it may be redundant to run the adapted genetic routing algorithm) the adapted genetic routing algorithm can initiate finding and/or optimizing a delivery route. Once, new requests are received the adapted genetic routing algorithm can use the previously found delivery plan and compute a new one to include the newly received requests.

In step S4, the requested item(s) in step S2 can be delivered using the at least one device for item delivery provided in step S1 according to the delivery routing plan computed in step S3. In other words, step S4 can consists of carrying out the delivery process. For example, the delivery system 60 (discussed with reference to FIGS. 1A to 1D) can be configured to carry out the delivery process according to the delivery routing plan computed in step S3. Put differently, the mobile robot 10 and (when provided) the transport apparatus 20 can be configured to operate according to the computed delivery plan. In addition, the location of the transfer location 3, distribution location 9 and/or meeting location 11 can be specified by the delivery routing plan (see FIG. 3). Furthermore, the order of deliveries and which item will be delivered by which device for item delivery can be specified in the delivery routing plan.

In step S5, while delivering the items according to the computed delivery routing plan, the method can comprise continuing to execute the adapted genetic routing algorithm and adapting the delivery routing plan if at least one further optimization is found. As can be apparent, step S5 can run concurrently with (or part of execution of) step S4.

Usually, computing an efficient routing plan is associated with finding optimal or nearly-optimal routing plans from a large searching space, i.e. there can be a large number of possible or candidate routing plans, which number can exponentially grow with the number of deliveries. As a consequence, finding an efficient routing plan may require a substantially long time. However, the sooner the delivery process can start the more efficient the delivery process can be, e.g. the lesser the delays and the larger the number of items that can be delivered on time. Thus, the method depicted in FIG. 2 can be configured to restrict step S3 (wherein the adapted genetic routing algorithm is firstly run) by a predetermined amount of time, e.g. 1-60 seconds. Hence, in step S3 a “good-enough” routing plan can be computed, i.e. a routing plan that at least fulfil some minimum requirements. Since the time of executing the genetic routing algorithm in step S3 may not be enough to compute an efficient delivery routing plan, step S5 allows for an extension of this time. That is, as the delivery process can be carried out in step S4, the genetic routing algorithm can continue to execute to find better routes. Update of the data provided to the genetic routing algorithm can be possible, such as, position of the mobile robots 10 and/or transport apparatuses 20, items already delivered, and the data provided by the genetic routing algorithm comprising the newly computed routing plans.

FIG. 3 depicts a data processing device 40 configured to compute an efficient delivery routing plan by executing an adapted genetic routing algorithm. Additionally, the input and output data to and from the data processing device 40 are schematically depicted. More specifically, an arrow pointed from an object to the data processing device 40, symbolically represents that the object comprises data which can be input to the data processing device 40 or data that can be stored in a memory unit (e.g. cache memory) which can be accessed by the data processing device 40. On the other hand, arrows pointing from the data processing device 40 to an object represents that the object the said arrow points to comprises data that can be outputted by the data processing device 40. Furthermore, in the schematic represented in FIG. 3, dashed arrows indicate optional data that can be input to the data processing device 40.

Thus, in some embodiments, at least one request for item deliver 31 from at least one user 30, delivery data 13, adapted genetic routing algorithm source code 50 and optionally map data 17 can be input to the data processing device 40. The data processing device 40 can process said input data, can execute the adapted genetic routing algorithm based on the instructions that can be provided in the adapted genetic routing algorithm source code 50 and can output a delivery routing plan 15.

A request for item delivery 31 can be provided by a user 30. The request for item delivery can comprise a location attribute 33, also referred as delivery address 33, and a time attribute 35. The location attribute 33 may specify an address or data regarding the location wherein requested item is to be delivered. In other words, a user 30 can request its item to be delivered at his/her preferred address through the location attribute 33. For example, the location attribute 33 can be the address of a building, e.g. the home or office of the recipient. The location attribute 33 may comprise fields comprising a street name, building number, entrance number, floor number, apartment number, zip code, city name and/or other fields or comments that can decrease the uncertainty about the location where a packet or requested item is to be delivered. On the other hand, the time attribute 35 may specify a time or time window when the packet is to be delivered at the specified location 33. The time attribute 35 may comprise fields comprising an hour (e.g. 15:00), a time window (e.g. 15:00-15:30), a date (e.g. dd.mm.yyyy or any other date format). The time attribute 35 may also comprise replicates of the time fields (such as the upper mentioned one) that may specify optional times or time windows when the requested item can be delivered.

Additionally, the request for item delivery 31 can comprise further information that may facilitate the logistics of item delivery. Further information may include name or id of the user 30 requesting the item, a class or a category of the item to be delivered (such as glass, liquid, etc.), weight or weight category of the item, dimensions or dimension category of the item. Said additional information, may either provided in the request for item delivery 31 or may be provided in another object or data structure, such as the delivery data 13.

Further, as an input to the data processing device 40 map data 17 may be provided. The map data 17 may comprise a representation of a delivery area 7 (see FIG. 1 or FIGS. 5A, 5B), such that it can be read and processed by the data processing device 40. The map data 17 may comprise the streets and the buildings present in a delivery area 7 associated with their relative positioning, size and shape.

The adapted genetic routing algorithm source code 50, also referred as source code 50, can comprise a set of instructions for carrying out the adapted genetic routing algorithm (for more details on the adapted genetic routing algorithm see FIGS. 4A and 4B). The source code 50 may be implemented in a programming language by a programmer. It can further be compiled by a compiler (e.g. a C++ compiler wherein the source code can be written in C++), which compiler may generate binary data or machine-readable code or object code (i.e. a binary representation of the adapted genetic routing algorithm). The object code can comprise instructions that can be decoded by the data processing device 40 and can instruct the data processing device 40 to execute operations, hence, making the data processing device 40 execute the adapted genetic routing algorithm.

The data processing device 40 can comprise processing cores, e.g. general-purpose processor. It can further comprise or have access to memory devices, such as caches, RAM, cache, HDD storage, SDD storage and the like. The data processing device 40 may comprise or be an embedded system, a system-on-chip, a PC, a server (e.g. online server).

In addition, the data processing device 40 can be provided with at least one constraint (not shown). The at least one constraint can comprise one or more conditions that should be fulfilled for delivering the items. The at least one constraint may comprise, a maximum (or average) delay per item, a maximum (or average) waiting time of a recipient, a maximum number of items that may not be delivered, a maximum number of delivery devices to utilize, a maximum duration to generate the routing plan, a maximum (or average) waiting time of a delivery device at the item loading location, a maximum (or average) time between the instant an item is ready and the instant the item is loaded on the delivery device, none of the delivery devices can run out of energy. The data processing device 40 can thus be configured to generate the routing plan such that it does not violate any of the provided constraints.

Based on the processing of the input data discussed above, the data processing device 40 can generate at least one delivery routing plan 15. The delivery routing plan 15 may comprise instructions on how to deliver the requested items.

For example, a delivery routing plan 15 may be a data structure in the form of a table, as depicted in FIG. 3a. The table of the delivery routing plan 15 may comprise for each of the deliveries a respective delivery ID field 1531, location field 1533, time field 1535 and transport device field 1510. The delivery ID field 1531 may comprise a unique ID that can be assigned to each of the deliveries to be performed. Further, the location field 1533 and time field 1535 can respectively comprise the location where the item(s) is planned to be delivered and the time when the item is planned to be delivered. The location field 1533, that is, the location where the item is planned to be delivered, may comprise a location as requested by the user 30 in the location attribute 33 of the request for item delivery 31, hence the item can be delivered at the desired location of respective user 30. Time field 1535, may comprise a delivery time as specified in the time attribute 35 of the request for item delivery 31 by the user 30. However, in some instances one or some of the items to be delivered may be planned to be delivered at a different time 1535 than the time attribute 35 specified in the request for item delivery 31. For example, if all the users 30 request the items to be delivered at same or close to each-other times 35, then it may not be possible to deliver all the requested items at the respective requested times 35, given a limited number of item transport devices. In addition, in some other instances, a user 30 may not specify a time attribute 35 during the request for item delivery 31. Hence, it may occur that in the computed delivery routing plan 15, some of the time field 1535 specifying the time when an item is planned to be delivered may differ from the time attribute 35 that may be specified during the request for item delivery 31.

However, it may be an objective of the adapted genetic routing algorithm to minimize the number of items that are not planned to be delivered at the time when the user 40 may have requested. That is, the delivery routing plan 15 may be computed, such that, the number of deliveries wherein the time field 1535 planned to deliver an item is equal or corresponds to the time attribute 35 as requested by a user 30 can be maximized. This may result in a better user 30 satisfaction.

The transport devices field 1510 of the delivery routing plan 15 can specify the item transport devices that can be used to deliver an item. For example, item of delivery ID “1”, is planned to be delivered at “Loc1.” at time “T1” using the “v1” transport apparatus 20 and the “m2” mobile robot 10. Note that “v1” and “m2” may comprise unique IDs of the transport apparatus 20 and mobile robot 10. Furthermore, the transport devices field 1510 may specify whether the item is planned to be transferred from the transport apparatus 20 to the mobile robot 10 (see FIG. 1C for details on item transfer) or whether the mobile robots 10 will be carried by the transport apparatus 20 and distributed at a distribution location 9 (see FIG. 1D for details in mobile robot distribution). That is, the transport devices field 1510 may specify the transport devices used (i.e. a mobile robot 10 or transport apparatus 20 or both) and the type of delivery (e.g. packet transfer or mobile robot distribution). Furthermore, when there is only one option or there cannot be any ambiguity some information may be omitted for the transport devices field 1510. For example, if there is only one transport apparatus 20 in the delivery system 60, then it can be redundant to specify the transport apparatus 20 plan to be used, in the transport devices field 1510 of the delivery routing plan 15. Same may hold true if there is only one mobile robot 10 used—the mobile robot 10 that is planned to be used may be omitted—or if the transport apparatus 20 is configured to either transfer items to at least one mobile robot 10 (see FIG. 1C) or carry mobile robots 10 and distribute them at a distribution location 9 (see FIG. 1D)—type of delivery may be omitted.

Furthermore, in some embodiments, the loading location 1 and/or transfer location 3 and/or distribution location 9 and/or meeting location 1 (see FIGS. 1A-1D) may not be fixed or predetermined locations. That is, the loading location 1 wherein the packets can be loaded to a transport apparatus 20 and/or to a mobile robot 10 may be selected from a plurality of location choices. Additionally or alternatively, the transfer location 3 wherein item can be transferred from a transport apparatus to at least one mobile robot 10 may be selected from a plurality of location choices. Similarly, the distribution location 9 wherein at least one mobile robot 10 carried in a transport apparatus 20 can be unloaded from the transport apparatus 20 and/or the meeting location 11 wherein the at least one mobile robot 10 can be loaded back to the transport apparatus 20 can be selected from a plurality of location choices. However, in some embodiments some of the upper-mentioned locations 1, 3, 9, 11 may be limited to one location. For example, the loading location 1 may be a facility configured for loading items to the transport devices 10, 20 and hence the loading location is fixed to one location. Yet in another example, there may be present a plurality of loading locations 1 however a requested item(s) is positioned in one specific loading location 1 and hence for such item(s) the loading location 1 is fixed to one location choice.

If multiple location choices can be present for any of the upper mentioned locations 1, 3, 9, 11 it can be understood that some of the choices or at least one of the choices may make the delivery routing plan 15 and the delivery process more efficient than other choices. For example, some or one of the choices may result in a smaller distance travelled by the transport apparatus 20 and/or mobile robot 10 for delivering the items. Thus, the selection of said locations, if multiple location choices can be available, can be computed by the data processing device 40 such that the efficiency of the delivery routing plan 15 can be optimized (or approach the optimum). The data processing device 40 may compute said locations and can output them in the delivery routing plan 15, more particularly, may output a loading location field 1501, specifying the computed efficient loading location 1, a transfer location field 1503, specifying the computed efficient transfer location 3, a distribution location field 1509, specifying the computed efficient distribution location 9 and a meeting location field 1511, specifying the computed efficient meeting location 11. If, as discussed, some of the locations are fixed or in case of no ambiguities, the respective delivery routing plan fields 1501, 1503, 1509 or 1511 may be omitted. For example, if the loading location 1 is fixed to one location, then it can be redundant to specify it in the loading location 1501.

Put differently, the data processing device 40 can be configured to compute a delivery routing plan 15. It can execute an adapted genetic routing algorithm from an adapted genetic routing algorithm source code 50. The adapted genetic routing algorithm may comprise an optimization problem that tries to optimize a cost function for generating an efficient routing plan 15 in terms of the cost function. The optimization problem may comprise some constraints, such as, number of transport devices available or time period for delivering the items, etc. Further constraints can be a fixed loading location 1 and/or fixed transfer location 3 and/or fixed distribution location 9 and/or fixed meeting location 11. It can be understood that constraints usually reduce the amount of available routing plans. For example, if only one transport device is present in a delivery system 60, there can be a routing plan of delivering items with same delivery time 35 at more than one location 33 without delay of at least one of the items.

However, some constraints may be relieved (i.e. more than one option can be provided). For example, a plurality of transport devices 10, 20, time windows 35, locations 33 for delivering items, loading locations 1, transfer locations 3, distribution locations 9, meeting locations 11 may be provided. Thus, the delivery routing plan 15 may be optimized by choosing appropriate choices from the available ones. The data processing device 40 can thus compute such choices executing the adapted genetic routing algorithm to generate an efficient routing plan 15. Thus, the data processing device 40 may assign to each delivery request 31 a location field 1533 and time field 1535 and a transport devices field 1510 in the delivery routing plan 15. In addition, the data processing device 40 may select or provide (when multiple options are available) a loading location field 1501, a transfer location field 1503, distribution location field 1509 and/or meeting location field 1511, such that, at least one objective of the delivery process can be reached (e.g. reducing cost of delivery, maximizing number of deliveries, minimizing delayed deliveries).

Though in FIGS. 3a and 3b the delivery routing plan 15 is represented in a tabular form, it should be understood that other forms or data structures may be used. For example, the routing plan may be represented in the form of a graph or tree as depicted graphically in FIG. 3c. Vertices or nodes of the graph may be configured to depict location fields or nodes 1533 and time fields or nodes 1535 of the delivery routing plan 15, graphically depicted in FIG. 3c by the filled circles. Other vertices in the graph may be configured to depict the loading location field or node 1501 of the delivery routing plan 15, specifying the loading location 1 where the items are to be loaded for delivery, graphically depicted in FIG. 3c by the square 1501. Other vertices may be configured to depict the transfer location field or node 1503, distribution location field or node 1509 and meeting location field or node 1511 as computed by the data processing device 40, graphically depicted in FIG. 3c by the round-cornered rectangles 1503, 1509 and 1511 respectively.

In addition, trajectories followed to reach from a first location to a second location may be depicted by the edges connecting the vertices of the graph. The trajectories may be a list of instructions, e.g. drive straight 100 meters, turn left, drive straight 630 meters, turn right, stop, location reached. The instructions may also be in a machine-readable form, hence facilitating the autonomous or nearly autonomous drive of the mobile robot 10 and/or transport apparatus 20, if configured for autonomous or nearly-autonomous driving. Edges may also be configured to depict dependencies or order of reaching the locations. For example, the transfer location 3 specified by the transfer location node 1503 is planned, in the delivery routing plan 15 depicted in FIG. 3c, to be reached before reaching Loc1 specified in the location node 1533. In addition, edges may be associated with information related to the transport devices used, graphically depicted in FIG. 3c by the tokens adjacent to the edges.

For example, the delivery plan depicted with the graph in FIG. 3c specifies the loading location 1 in the loading location node 1501. It also specifies a transfer location 3 in the transfer location node 1503, a distribution location 9 in the distribution location node 1509 and a meeting location 11 in the meeting location node 1511. Additionally, the graph specifies deliveries “1” and “2” to be performed by loading the respective items in the “v1” transport apparatus and then transferring them at transfer location 3 specified in the transfer location node 1503 to mobile robots “m2” for delivery “1” and “m1” for delivery “2”. Further, it specifies that delivery “n” is to be delivered with “v2” transport apparatus 20 carrying the mobile robot “m3”, distributing it at distribution location as specified by distribution location node 1509. The mobile robot “m3”, then delivers the item at location “Locn” at time “Tn” and reaches meeting location 11 as specified in the meeting location node 1511 to meet the transport apparatus 20, which also approaches meeting location 11 after distributing the mobile robot “m3”. Note, that same information is also contained in the tabular representation of the delivery plan 15 depicted in FIGS. 3b and 3c.

Below, with reference to FIGS. 4A and 4B embodiments of an adapted genetic routing algorithm will be described.

FIG. 4A depicts a flowchart describing an adapted genetic routing algorithm 50. The adapted genetic routing algorithm 50 can be used in the method depicted in FIG. 2 and/or with any of the systems depicted in FIGS. 1A to 1D and/or can be executed by the data processing device 40 to compute a delivery routing plan 15 depicted in FIG. 3. FIG. 4B depicts objects or data structures and operation that can be used or preformed during the execution of the adapted genetic routing algorithm 50.

The adapted genetic routing algorithm 50 can be configured for generating a delivery routing plan 15 (see FIG. 3) under a set of constraints. Such constraints may include a set of deliveries 5001. The set of deliveries 5001 comprises the deliveries that need to be performed for which the adapted genetic routing algorithm 50 can be configured to generate a delivery routing plan 15. For example, the set of deliveries 5001 may comprise at least one request for item delivery 31 (see FIG. 3). Each delivery in the set of deliveries 5001 may be represented or encoded (e.g. in a computer-readable form) by a data structure comprising the details of the delivery (such as delivery location, requested time for delivery, delivery ID). Deliveries on the set of deliveries 5001 may also be represented or encoded (e.g. in a computer-readable from) by a delivery ID which can be unique to a delivery 30 and can be used to point to more details of the respective delivery 30. In FIG. 4B, for simplicity, the deliveries are represented by the acronyms “D1”, “D2”, “D3” and “D4”. Though, in this example the set of deliveries 5001 comprises 4 deliveries, in general it can comprise any number of deliveries, such as, at least 2 deliveries and at most 400 deliveries, preferably at most 300 deliveries. It will be understood, that the adapted genetic algorithm 50 can be used with any number of deliveries. However, as the number of required computations generally grows with the number of deliveries, the performance (e.g. time required to compute an efficient delivery plan 15) can become worse (e.g. more time can be required) with the increase of number of deliveries, especially with very large number of deliveries (e.g. more than 400 deliveries).

Further constraints may include the set of transport apparatuses 5020 and the set of mobile robots 5010 that can be used for the delivery process. In the provided example, the set of transport apparatuses 5020 comprises two transport apparatuses 20, represented with acronyms “V1” and “V2”, configured as a second transport device 20 and the set of mobile robots 5010 comprises four mobile robots 10, represented with acronyms “M1”, “M2”, “M3”, “M4”, configured as a first transport device 10. In general, the set of transport apparatuses 5020 and the set of mobile robots 5010 can comprise any number of transport apparatuses 20 and mobile robots 10.

The transport apparatuses 20 may be represented or encoded in the set of transport apparatuses 5020 by a data structure comprising further details regarding the respective transport apparatus 20, such as, available energy, maximum distance it can travel and carrying capacity (such as, package carrying capacity and/or mobile robot carrying capacity). Similarly, the mobile robots 10 may be represented or encoded in the set of mobile robots 5010 by a data structure comprising further details regarding the respective mobile robot 10, such as, available energy, maximum distance it can travel and carrying capacity (such as, package carrying capacity). The mobile robots 10 and the transport apparatus 20 can also be represented or encoded in their respective sets 5010, 5020 using unique IDs that can point to further information, such as, to data structures comprising such information. Further constraints may comprise at least one path 5007 that can be followed by either the transport apparatuses 20 or the mobile robots 10 or both. A path 5007 can comprise a trajectory that can lead to a delivery location 33. The path 5007 can comprise a loading location 1 and a delivery location 33 and additionally a trajectory (or set of streets) that can be followed to travel from the loading location 1 to the delivery location 33. Further, the path may comprise intermediate locations, such as, a transfer location 3 and/or a distribution location 9 and/or a meeting location 11.

Path 5007 may further comprise an energy station 19. The energy station 19 can be a location wherein the mobile robot 10 and/or the transport apparatus 20 can receive energy used for their operation. For example, the energy station 19 may be a battery charging station 19, wherein the mobile robot 10 and/or the transport apparatus 20 can charge their batteries and/or receive charged batteries—wherein the mobile robot 10 and/or the transport apparatus 20 use batteries for their operations, such as navigating and driving. The energy station 19 may also be a fuel filling station 19, wherein the mobile robot 10 and/or the transport apparatus 20 can receive fuel which is used as energy source for their operations, such as driving.

Path 5007 can be based on map data, such as, a network of streets and buildings (e.g. see FIGS. 5A and 5B). For example, path 5007 may be based on a map of a delivery area 7 (see FIGS. 1A to 1D). A set of locations can be highlighted or marked or noted or encoded, such that, marked locations can be distinguished from the other locations comprised in the map data path 5007 can be based on. Preferably, the marked locations can be encoded such that a machine (i.e. data processing device) may distinguish it from other locations on the map. Further, the marked locations can comprise at least one of: at least one loading location 1, at least one transfer location 3, at least one energy station 19, at least one delivery location 33, at least one distribution location 9, at least one meeting location 11. Put simply, path 5007 may be generated using map data, said map data used to infer the position of a set of marked positions and the trajectory (or set of streets) used to reach the set of marked locations.

Path 5007 can be configured to provide instructions for reaching from an initial location to a destination or from an initial location to at least one intermediate location and then to a destination. For example, path 5007 can comprise instructions on how to reach a delivery location 33 from a loading location 1 or how to travel from a loading location 1 to a distribution location 9, then to an energy station 19, then to a delivery location 33, then to a meeting location 11 and then back to the loading location 1. Furthermore, by changing an initial location and/or intermediate location and/or destination the path can be adapted, preferably automatically—e.g. by a program using a map to find a path. For example, changing the delivery address 33 the path 5007 can be adapted such that the delivery address can be reached. Hence, for each delivery 30 a respective path 5007 can be assigned to.

Under such constrains, the adapted genetic routing algorithm 50 can be configured to generate a delivery routing plan 15. That is, the adapted genetic routing plan 50 can be configured to find a delivery routing plan 15 comprising a set of adapted paths 5007, such that, preferably all the deliveries in the set of deliveries 5001 can be performed using at least one of the transport apparatuses 20 comprised in the set of transport apparatuses 5020 and at least one mobile robot 10 comprised in the set of mobile robots 10.

The present adapted genetic routing algorithm 50 is a genetic algorithm. As known by the person skilled in the art, genetic algorithms are based on an evolutionary analogy from evolution. Hence, terms from biology such as population, generation, individual, selection, fitness, chromosome, gene allele, mutation, crossover are inherited for describing elements or operations involved in genetic algorithms. As it is apparent to a person skilled in the art, a detailed description of the meaning of such terms will be omitted.

The term population 5100, generation 5100 or set of solutions 5100 are interchangeably used in this description. A population 5100 can comprise a set of possible solutions 5102, also referred as individuals 5102 or chromosomes 5102. A generation 5100 refers to an instance of population at a point in time. Each individual 5102 of the population 5100 can comprise at least one gene 5104, preferably a set of genes 5104. A gene 5104 can describe a characteristic of the solution 5102. A chromosome 5102 can comprise different types of genes, such as: a time gene 5104T specifying the time when the delivery should initiate and/or terminate; a delivery gene 5104D comprising details regarding a delivery, such as, a delivery ID; a second transport device gene 5104V specifying the transport apparatus 20 that should be used for performing the delivery specified in the delivery gene 5104D; a first transport device 5104M specifying the mobile robot 10 that should be used to perform the delivery specified by the delivery gene 5104D; a path gene 5104P specifying the path 5007 that should be used to perform the delivery specified by the delivery gene 5104D.

Note that in FIG. 4B, not to overload the figure, only the genes of one chromosome are provided numerals.

The adapted genetic routing algorithm 50 can start with a population initialization process 51 which can be configured to generate an initial population 5100 (i.e. the first generation 5100). This can be done with a random population generation subprocess 511 or population seeding subprocess 513.

The random population generation subprocess 511 can randomly combine genes 5104 to construct chromosomes 5102. For example, for each delivery 30 from the set of deliveries 5001 a respective chromosome can be constructed, comprising in addition to the respective delivery gene 5104D, a time gene 5104T, a first transport device gene 5104M, a second transport device gene 5104V and a path gene 5104P, wherein values for genes are randomly selected. That is, for the time gene 5104T a random time (within a time interval) can be chosen. Further, for the first transport device gene 5014V a random transport apparatus 20 can be randomly selected from the set of transport apparatuses 5020. Further still, for the first transport device gene 5104M a random mobile robot 10 can be randomly selected from the set of mobile robots 5010. Note, that the path gene 5104P may not be selected entirely at random as the loading location 1 and delivery location 33 may be determined by the chosen delivery 30—i.e. the respective item of the delivery may be positioned at a specific loading location 1 and the delivery location 33 may be determined by the user. Thus, the loading location 1 and delivery location 33 can be determined by the delivery 30 and cannot be selected at random if the delivery gene 5104D already specifies a delivery 30. However, other intermediate locations, such as, the transfer location 33 and/or distribution location 9 and/or meeting location 11 and/or energy station 19 may be selected at random. Further, the trajectory leading from the loading location 1, to intermediate locations, to the delivery location 33 can be selected at random. Hence, a random initial population 5100 can be constructed comprising at least one solution 5102 for each delivery 30 from the set of deliveries 5001.

On the other hand, the population seeding subprocess 513 can use a “seed delivery plan”, That is, the population 5100 can be initialized using a previously generated delivery plan 15 and evolving it, such that, a more efficient delivery plan 15 can be produced. In this case, the adapted genetic routing algorithm 50 can be used for further improvements on a previous delivery plan. In some other instances, the adapted genetic routing algorithm 50 can be used to extend a previously calculated delivery plan 15. Hence, the previously calculated delivery plan 15 can be seeded as initial population to the adapted genetic routing algorithm 50, through subprocess 513. Then, further or new deliveries 30 can be added and a new delivery plan 15 can be computed including the newly added deliveries 30. For example, population 5100A, may be a case wherein a population comprising chromosomes with genes D1, D2 and D4 are seeded. Then, chromosome with the gene D3 that needs to be performed at time T3 can further be added. The adapted genetic routing algorithm 50 can thus compute a new delivery plan 15 including delivery D3.

The adapted genetic routing algorithm 50 can comprise a generation evaluation process 52. That is, each generation 5100 can be subsequently evaluated to ascertain the fitness of the individuals 5102. The solutions 5102 can be evaluated to determine how well they can solve the delivery routing problem or how efficient the delivery process can be using solutions 5102. This can be achieved by assigning a cost to the paths 5007 that can be followed for completing each delivery. The cost can be assigned to a path 5007 in terms of: distance travelled by the mobile robot 10 and/or transport apparatus 20 for traversing the path 5007 (i.e. length of the path 5007); time spent for traversing the path 5007 and completing respective delivery (i.e. time needed to traverse path 5007); time of the day; delivery area 7 (see FIGS. 1A to 1D) comprising the delivery addresses 33, fuel that can be consumed by the transport devices 10 and/or 20 to traverse path 5007 and complete respective delivery; electrical energy or other type of energy that can be spent for traversing the path 5007 and complete respective delivery; number of mobile robots 10 and/or transport apparatuses required to traverse the path 5007 and complete the respective delivery; number of human employees that can be involved in the process; accordance with regulations or laws, e.g. traffic laws; or other factors affecting the economics of the logistics operation.

Note that the cost assigned to a path 5007 comprised in the path gene 5104P of a solution or individual 5102 can also correspond to the cost of said solution 5102 or individual 5102.

The cost function may consider the upper-mentioned factors individually or in combination with each other. For example, if multiple factors are considered the cost function can be expressed by summing weighted versions of the considered factors, wherein each factor can be assigned a weight (e.g. a constant between 0 and 1) and can be multiplied with the respective weight before summation. Weighting the cost factors allows some of them to be prioritized over others. Weights can also be all assigned to the same value (e.g. 1), providing no prioritization of factors. Further, it can be advantageous to represent the cost quantitively, i.e. the cost function may quantitively be computed for a solution or individual 5102. In other words, the cost can be a number representing a quantity, category, level, etc. This can facilitate the calculation and evaluation of fitness values for the individuals.

For example, the cost function may be configured for evaluating the distance travelled by the transport apparatus 20 and/or the mobile robot 10. Objective of the adapted genetic routing algorithm 50 can be to minimize the cost function, that is, minimize travelled distance. The cost function can be quantitively computed, i.e. for a certain solution 5102 it can be the distance travelled in meters (or other distance unit measures). Hence, for each individual 5102 or path 5007 a fitness value can be assigned, representing the distance that needs to be travelled to complete the respective delivery 30 (which is specified in the respective delivery gene 5104D of the individual).

Further, a cost can be assigned to a generation or population 5100 by combining (e.g. adding) the cost of comprised individuals 5102. That is, for each path 5007 a cost can be calculated which can correspond to the cost of the respective individual 5102 comprising path 5007 in its path gene 5104P and costs of each individual 5102 in a generation 5100 can be combined to calculate the cost of the generations 5100.

Additionally, the generation evaluation process 52 may comprise a constraint fulfilment check subprocess 523. A constraint within the context of subprocess 523, relate to conditions that need to be fulfilled for a normal operation of the delivery process. These constraints usually include critical constraints, such as, maximum traveling speed, maximum driving range, maximum capacity, driver or operator duty hours (in case the transport apparatus 20 and/or mobile robot 10 are not fully autonomous), accordance with traffic rules.

Thus, it can be advantageous that solutions 5102 of each generation 5100 can be validated to verify that they can fit all or a selected number of constraints. In some embodiments, individuals 5102 that cannot fulfil all or a selected number of constraints can be discarded or modified such as to fit the constraints. Subprocess 523 can be configured to ensure that each solution 5102 can fulfil the predefined constraints. For example, a random mutation may assign to a mobile robot 10 to travel more than its maximum driving range. Such solution 5102 can comprise a high fitness, hence allowing it to survive. However, though the fitness of said solution 5102 may be better than of others, it is not a realizable solution, as the mobile robot 10 cannot drive more than its maximum driving range. Thus, the check constraint fulfilment subprocess 523, can allow detection of unfeasible solutions 5102. Further, subprocess 523 may discard such solutions 5102. Alternatively, subprocess 523 can modify unfeasible solutions 523 such that they can fulfil the constrains. In the above example, the unfeasible solution can be modified, such that, another mobile robot 10 with higher driving range can be assigned to the task, or an energy station 19 can be included in the path of the mobile robot 10, hence allowing it to travel the assigned long distance.

In other words, during the operation of the adapted genetic routing algorithm 50, new solutions 5102 are generated. In some instances, as it will become apparent in the following description, some individuals 5102 can be generated using random operations (see subprocess 533).

Further, the adapted genetic routing algorithm 50 can comprise a change current generation process 53. Process 53 can be configured to create a new generation 5100, i.e. a new instance of population 5100, based on changes conducted on a previous generation 5100. The changes can be governed by different operators acting on the set of individuals 5102 of a population 5100. Such operators may include crossovers 531, random mutations 533, domain specific mutations 535 and/or discarding of individuals 537.

Crossover operation 531, can involve combining at least two parent individuals 5102 to obtain a child solution 5102. The child individuals 5102 can inherit characteristics or genes 5104 from the at least two parents. Different types of crossovers or combinations of parent individuals 5102 can be used with the purpose of obtaining new child individuals 5102 inheriting at least one gene from the parent individuals 5102.

Usually, at an instance of time, a parent individual 5102 can be part of a previous generation 5100 and may or may not be part of the next generation—based on its fitness. A child individual 5102, on the other hand, cannot be part of a previous generation 5100, as they are produced using individuals of the previous generation, and may or may not be part of the next generation 5100—based on its fitness.

Random mutation operation 533 can comprise selecting a gene 5104 and changing its value, wherein either the selection of the gene or the selection of the new value assigned to a gene or both can be randomly preformed. The random mutation operation 533 can provide diversity to the new generations 5100. Diversity on a generation 5100 can be advantageous as it can allow the algorithm to escape local minimums (or maximums) and hence increasing the chance to obtain an optimal solution (the global minimum or maximum). That is, the adapted genetic routing algorithm 50, as discussed, is configured to generate a delivery routing plan 15. For efficient delivery process, the adapted genetic routing algorithm 50 may be configured to minimize a cost function. While the cost function, may comprise a global minimum (i.e. smallest values the function can reach, the optimal solution), it can further comprise local minimums (i.e. smallest value on range). Usually, optimization algorithms can get “stuck” on such local minimums, hence producing a value which may not be optimal or nearly-optimal. Randomization, can allow optimization problems, such as, the adapted genetic routing algorithm 50 configured to generate an optimized delivery plan 15, to escape local minimums, hence increasing the probability of finding the global minimum.

Nevertheless, usually the random mutation 533 rate is chosen to be small, as otherwise the genetic algorithm can result in a random search, hence taking a substantially long time to converge—i.e. find an optimal or good-enough solution.

Domain-specific mutation operation 535 can comprise selecting a gene 5104 of a solution 5102 and changing its value. Domain-specific mutation operation 535 can encode some knowledge of the specific domain that the algorithm is being used to—i.e. knowledge regarding the logistics of the delivery process. That is, in contrast to the random mutation operation 533, wherein the selection and/or change of a gene 5104 is randomly performed, the domain-specific mutation operation 535 can employee information regarding the delivery system and/or process, which can be provide in advance, to conduct mutations.

The domain-specific mutation operation 535 can comprise assigning values to empty genes 5104 of an individual. For example, referring to FIG. 4b, the transition from generation 5100A to 5100B, demonstrates such domain specific mutations, wherein to the delivery task D3, the transport apparatus “V2”, mobile robot “M3” and path “P3” are assigned to the respective genes. Similarly, domain-specific mutation operation 535 can comprise clearing or emptying the value of a gene 5104 (not shown). In other words, domain-specific mutation operation 535 may clear and assign the value of a gene 5104.

The domain-specific mutation operation 535 may comprise re-assigning a delivery task from one mobile robot 10 to another mobile robot 10 and/or from one transport apparatus 20 to another transport apparatus 20. For example, referring to FIG. 4B, the transition from generation 5100B to 5100C demonstrates such domain-specific mutations. As it can be noticed, delivery with the depicted ID “D2” is re-assigned from mobile robot “M2” to mobile robot “M1”.

Further, the domain-specific mutation operation 535 can comprise replacing a plan to perform a delivery task using a single mobile robot 10, by a plan to perform the delivery using an additional transport device, such as, a transport apparatus 20. That is, instead of delivering an item using a single mobile robot 10, a mutation can change the plan such that, the item can be delivered using a transport apparatus 20 that carries the item to a transfer location 3 and overhand the item to a mobile robot 10. For example, in FIG. 4b said mutation is demonstrated by the transition from generation 5100B to generation 5100C. In a previous plan, in generation 5100B, delivery task “D1” is planned to be delivered using only the mobile robot “M1”. A domain-specific mutation operation 535, can assign transport apparatus “V1” to the respective second transport device gene 5104V. Hence, in the new plan, in generation 5100C, the delivery task “D1” is planned to be delivered using transport apparatus “V1” and mobile robot “M1”. Similarly, instead of adding a transport device to a plan, as described above, some domain-specific mutation operations 535 may remove a transport device from a plan. For example, during the transition from generation 5100B to population 5100C, vehicle “V2” is removed from the delivery task “D4”, hence assigning the delivery task “D4” to be performed using only mobile robot “M4”.

Further, a domain-specific mutation operation 535 may cause changes on the path gene 5104P of a solution 5102. Such mutations may comprise adding or removing or changing location of at least one of: transfer location 3, energy station 19, distribution location 9 and meeting location 11. In some instance, the loading location 1 and delivery location 33 may be added or changed. Further, said mutation may comprise changing the route, i.e. the streets or trajectory leading from one location another. For example, in FIG. 4B, paths “P1” and “P4” are changed to “P1′” and “P4′” respectively, during transition from generation 5100C to generation 5100D. For example, path “P1′” may be mutated to include a transfer location 3, wherein the transport apparatus “V1” can transfer at least one item to mobile robot “M1”. Similarly, path “P4′” may be mutated to remove a transfer location 3 from the path.

A domain-specific mutation operation 535 may also comprise a mutation to route a mobile robot 10 to an intermediate stop at an energy station 19 to ensure it has enough energy to complete the assigned task. For example, path gene “P3′” may result after a domain specific mutation 535 adds an energy station 19 to the respective path gene “P3” of delivery “D3” during the transition from generation 5100C to generation 5100D. Hence, the mobile robot “M3” can drive to the energy station 19 before delivering the item.

Further, a domain-specific mutation operation 535 can comprise swapping the time-wise ordering of two successive deliveries. For example, referring to FIG. 4B, during transition from generation 5100D to generation 5100E, a domain-specific mutation 535 caused deliveries “D1” and “D2” to be swapped time-wise (denoted by the curved arrows). Hence, the domain-specific mutation changed the plan for the mobile robot “M1”, which is assigned with the task to perform both deliveries “D1” and “D2”, to perform delivery “D2” before performing delivery “D1”. Note that for simplicity, the time-wise ordering of deliveries for the same vehicle, is depicted as the ordering on the list of delivery genes 5102 provided in each generation 5100. Nonetheless, deliveries performed by different vehicles can also be accomplished in parallel.

Further still, a domain-specific mutation operation 535 can comprise a mutation to remove a fulfilled delivery task from the plan, as depicted in FIG. 4B during the transition from generation 5100E to generation 5100F, wherein delivery “D2” is removed. Such mutations, can be particularly advantageous, when the adapted genetic routing algorithm 50 can be executed while the delivery process is undergoing. Hence, completed deliveries can be removed from the delivery plan and new optimizations, adaptations or changes to the delivery plan, comprising less deliveries, can be performed.

The change current generation process 53, can additionally comprise individual discarding subprocess 537. The individual discarding subprocess 537 can remove at least one individual 5102 from a generation 5100, when performed. The at least one individual 5102 to be removed from a generation 5100 may be chosen randomly. The removal of at least one individual 5102 in the individual discarding subprocess 537 can also be based on predefined criteria. For example, the individual discarding subprocess 537 may be executed with the generation evaluation process 52 and an individual 5102 can be discarded if the individual 5102 comprises a low fitness (see subprocess 521) and/or does not fulfil one or more constraints (see subprocess 523). The individual discard subprocess 537 may also discard individuals 5102 that can make a delivery plan unrealizable. For example, if two individuals 5102 comprise the same mobile robot 10 performing two different deliveries at the same time or at intersecting time intervals, then at least one them should be removed to make the plan feasible.

In a further process 54, the adapted genetic routing algorithm 50 can comprise selecting individuals for next generation. That is, the algorithm can comprise an individual selection for next generation process 54. As discussed, in the change current generation process 53 new individuals 5102 can be generated through crossovers (step 531), mutations (step 535 and 533). Further, some or all of the individuals 5102 from the previous generation 5100 may still be present (i.e. alive). Additionally still, size of a generation 5100 (i.e. number of individuals 5102 in the generation 5100) can be limited either by a maximum number of individuals (which can be a parameter provided to the algorithm) or by predefined criteria, such minimum fitness or both. Based on the limits that can be imposed to the size of a generation 5100, the selection of individuals in process 54 can be performed. For example, N individuals with the best fitness can be selected, wherein N denotes the maximum number of individuals 5102 a generation 5100 can comprise. Similarly, individuals with a fitness of no less than F can be chosen, wherein F denotes the minimum fitness of an individual 5102 of a generation. In the former example the size of the generation 5100 is fixed (e.g. to the number of deliveries to be performed) and in the latter case the size of the generation 5100 may vary.

Hence, at completion of individuals selection process 54, a new generation 5100 can be generated. The new generation 5100 can comprise individuals 5100 from the previous generation and new individuals generated during the crossover operation 531 and/or random mutation operation 533 and/or domain-specific mutation operation 535.

Further, the adapted genetic routing algorithm 50, at the completion of individual selection for next generation process 54 can loop back at generation evaluation process 52, as depicted in FIG. 4A, wherein the new generation 5100 can be evaluated.

Alternatively, individual selection for next generation process 54 may also be incorporated with the generation evaluation process 52. This can be particularly advantageous when the selection of individuals for next generation takes the fitness of individuals and/or constraint fulfilment of individuals into considerations. That is, instead of comprising two distinct steps, generation evaluation process 52 and individual selection 54 as depicted in FIG. 4A, the algorithm can comprise one step wherein fitness of individuals can be calculated, individuals can be checked if they fulfil constraints and individuals can be selected for next generation.

Further, in a step 55, the fulfilment of the termination condition can be checked. The termination condition can specify one or a set of conditions, that when fulfilled terminate the algorithm.

The termination condition can comprise a time limited that can specifies the maximum time that the algorithm can be allowed to run. At the termination of the time limit, the algorithm can be stopped or interrupted and the current generation of the algorithm at interruption can be used to generate the delivery plan.

The termination condition can further comprise a maximum cost that can be expected or tolerated from a delivery plan. As discussed, the adapted genetic routing algorithm 50 can be configured with the objective of minimizing the cost of delivery process. A maximum tolerable cost can be specified in the termination condition of step 55, i.e. maximum cost that a generation 5100 can comprise. When the cost of a generation 5100, as can be calculated during generation evaluation step, becomes smaller than the maximum tolerable cost the algorithm can be terminated.

Step 55 is advantageous as otherwise the adapted genetic routing algorithm can run “forever”. As it can be noticed form FIG. 4A, steps 52, 53, 54 and 56 form a loop. Without the termination condition 55, steps 52, 53 and 54 can be stuck into an infinite loop. Thus, configuring a termination condition for the adapted genetic routing algorithm 50 and continuously checking the fulfilment of the termination condition in step 55, limits the time or number of cycles the said loop can be executed.

Rationally, if the termination condition is not fulfilled, step 55 can be followed by step 53. That is, the adapted genetic routing algorithm 50 continues execution by generating a new generation and evaluating it and checking if the new generation causes the termination condition to be fulfilled or the time interruption is reached.

Otherwise, if the termination condition is fulfilled, step 55 can be followed by step 56. The output generation process 56 can be configured to generate a delivery plan 15 (see FIG. 3). That is, the last generation 5100 of the adapted genetic routing algorithm 50 before termination can be used to generate the delivery plan 15.

FIG. 5A illustrates the execution of a delivery routing plan. More particularly, in FIG. 5A the trace of a delivery process being carried out by a delivery system is depicted.

The delivery area 7 can be represented as a network of streets 71, wherein multiple locations (such as, the delivery locations 33 and loading location 1) can be differentiated or addressed. The network of streets 71 can at comprise interconnections (roads, streets, sidewalks, driveways) between, but not limited to, the addressable locations (such as, the delivery locations 33 and loading location 1), which network of streets 71 can be traversed by mobile robots 10 and/or transport apparatuses 20.

In addition, in FIG. 5A, the delivery locations 33 are depicted, marked in the delivery area 7 by the filled circles D1, D2, . . . , D15. Hence, as also planned in the delivery plan 15, there are in total 15 deliveries to be carried out, in the example provided. More particularly, the delivery IDs can be specified in the delivery ID field 1531 of the delivery plan 15 It should be understood that the delivery plan 15, also comprises the omitted deliveries D3 to D14, which are not depicted in the figure not to overload it—details regarding deliveries D3 to D14 can be inferred following the trend depicted by the depicted rows on the delivery plan 15.

As discussed with respect to FIG. 3, associated with each delivery ID can be a location field 1533 and time field 1535 and a transport device field 1510. For example, delivery D1 should is planned to be delivered ad location Loc1 at time T1 using the mobile robot m1. Further, all the deliveries are carried out using a single mobile robot 10 (the mobile robot m1).

The path followed to carry out the delivery process is depicted in FIG. 5A by the mobile robot trajectory 101. The mobile robot trajectory 101 may comprise streets, roads, driveways, sidewalks and/or pass-ways.

Before beginning item distribution, the mobile robot 10 can be loaded with items in a loading location 1, referred here as Loc_Load. Loading location 1 is correspondingly specified in the loading location field 1501 of the delivery plan 15. As there is only one transport device used, there is no package transfer or robot distribution being planned, hence the respective fields 1503, 1509 and 1511 are empty.

FIG. 5B illustrates another delivery process carried out according to a delivery plan. Similar to FIG. 5a, a delivery area 7 is depicted. In the delivery area 7 three delivery locations 33 are depicted with referrals D1, D2 and D3. The delivery routing plan 15 providing the plan to carry out the delivery process of deliveries D1, D2 and D3 is also provided.

Thus, as it can be noticed, the delivery plan 15 comprises in the delivery ID field 1531 the three deliveries D1, D2, D3 to be carried out at respective locations Loc1, Loc2 and Loc3 and during respective times T1, T2 and T3. Further, the transport devices to be used for carrying out the deliveries is provided for each delivery in the transport device field 1510. Further still, the path followed by the transport devices for carrying out the deliveries can be specified by the loading location field 1501, transfer location field 1503, distribution location field 1509 and meeting location field 1511.

Hence, referring to the graphical representation and the delivery plan 15, items to be delivered can be loaded to the mobile transport apparatus v1 at loading location 1, referred as Load_Loc. Further the, mobile robots m1 and m2 are loaded to the mobile transport apparatus v1 at the loading location Load_Loc. The transport apparatus v1, carrying mobile robots m1 and m2 and the items to be delivered of deliveries D1, D2 and D3, following trajectory 201 drives from loading location Load_Loc to the distribution location 9, referred herein as D_Loc. In the distribution location D_Loc, the mobile robots m1 and m2 can exit the mobile transport apparatus v1. Mobile robot m1 can deliver item of delivery D1 to delivery location Loc1 at time of delivery T1—as specified in the delivery plan 15. Similarly, mobile robot m2 can deliver item of delivery D2 to delivery location Loc2 at time of delivery T2. After carrying out the respective deliveries, mobile robots m1 and m3 approach the meeting location 11, referred as T/M_Loc.

On the other hand, the mobile transport apparatus v1 after distributing mobile robots m1 and m2 approaches the transfer location 3, referred as T/M_Loc, wherein the mobile transport apparatus v1 can transfer item of delivery D3 to mobile robot m3. The mobile robot m3 can carry out delivery D3 and approach the meeting location 11, referred as T/M_Loc. Note that in this example, the transfer location 3 and meeting location 11 are the same location T/M_Loc.

In the meeting location T/M_Loc the mobile robots m1, m2 and m3 can be loaded to the mobile transport apparatus v1 and the mobile transport apparatus v1 can leave the meeting location T/M_Loc following trajectory 201.

Note that in FIGS. 5A and 5B exemplary delivery processes are provided and described to illustrate how a delivery process can be carried out using a delivery system 60 based on a delivery plan 15. FIGS. 5A and 5B are illustrative examples and do not limit the scope of the invention in any way.

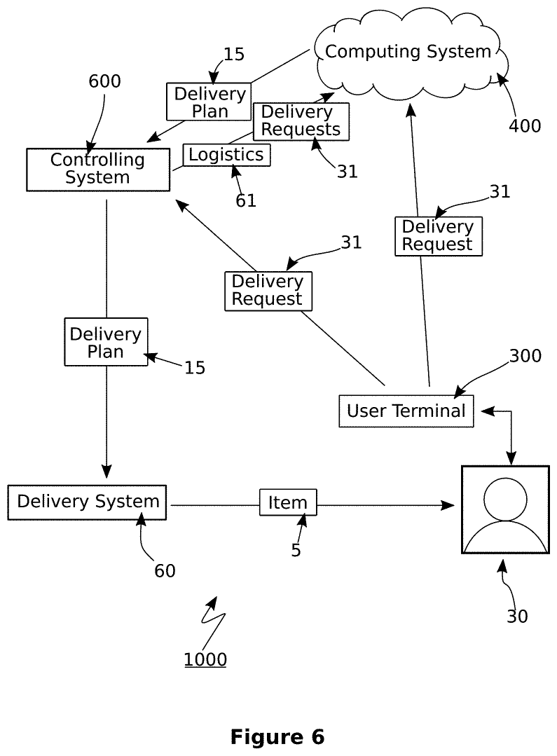

Referring to FIG. 6 a system 1000 configured for receiving delivery requests, computing a delivery plan to complete the delivery requests and carrying out the delivery process is depicted.

The system 1000 can be used by a user 30. The user 30, using a user terminal 300 can input to the system 1000 a delivery request 31. The user terminal 300 can be a computer, laptop, tablet, smartphone. In general, terminal 300 can be any device that can be configured to establish a communication link, e.g. through Internet or cellular technology, with system 1000. The delivery request 31 can be a request for item delivery that can allow the user 30 to specify an item 5 he/she can require and an address of the destination to deliver the item 5 and/or a time when to deliver the item 5. For example, as depicted in FIG. 3, the delivery request 31 can comprise a location attribute 33 and a time attribute 35 for specifying the delivery destination and time of delivery.

The system 1000 can comprise a computing system 400, a controlling system 600 and a delivery system 60.

User 30 can provide his/her delivery request 31 either to the controlling system 600 or to the computing system 400 or both. Preferably, a communication connection, e.g. through Internet or cellular technology, can be established between the user terminal 300 and the controlling system 600 and/or the user terminal 300 and/or computing system 400 allowing the user 30 to remotely provide his/her delivery request 31.

The computing system 400 can be configured to receive a plurality of delivery requests 31. In some embodiments, system 1000 can be configured such that the delivery requests 31 can be provided to computing system 400 directly from user terminal 300 of user 30. Alternatively or additionally, system 1000 can be configured such that the delivery requests 31 can be communicated from the user terminal 300 to the controlling system 600 and from the controlling system 600 to the computing system 400. Further, the computing system 400 can be configured to receive logistic data 61 that describe or provide information regarding the delivery system 60. For example, logistic data 61 may specify the number of the mobile robots 10 and/or transports apparatuses 20 of delivery system 60 that can be available. Logistic data 61 may further comprise constraints regarding capacities of the transport devices 10, 20, maximum distance that can be travelled by each transport device 10, 20, working hours of employees of delivery system that can limit the time span of delivery process, map data of the delivery area wherein deliveries are to be performed, constraints on paths on the delivery area that can be followed, maximum tolerable cost, definition of the cost (e.g. in terms of distance travelled by the transport devices 10, 20 and number of deliveries performed) etc.

The computing system 400 can be configured to compute a delivery plan 15, using the adapted genetic routing algorithm 50 described in FIGS. 4A and 4B, based on the at least one delivery request 31 and logistic data 61. The computing system 30 can comprise at least one data processing device 40 (see FIG. 3), which it can utilize to compute the delivery plan 15 using the adapted genetic routing algorithm 50. The computing system 400 can further be configured to transfer the computed delivery plan 15 to the controlling system 600.

The computing system 400 can be a server 400. In some embodiments, the computing server can be a cloud server 400 configured to host at least one controlling system 600.

Hence, the controlling system 600 can use the computing capacities of the computing system 400 for receiving a delivery plan 15 computed based on the logistic data 61 and the plurality of delivery requests 31. The cloud server 400 can comprise the data processing device 40 (see FIG. 3).

The controlling system 600 can be configured to control the delivery system 60 and provide logistic data 61 to the computing system 400 and/or receive delivery requests 31 from at least one user 30 and provide the received delivery requests 31 to the computing system 400. The controlling system 600 can be further configured to receive a delivery plan 15 from the computing system 400. Based on the received delivery plan 15 the controlling system 600 can control or provide instructions to the delivery system 60. In other words, the controlling system 600 can operate the delivery system 60 to carry out the delivery plan 15.

As discussed in FIG. 1, the delivery system 60 can comprise at least one mobile robot 10 and/or at least one transport apparatus 20, wherein the carrying capacity of the transport apparatus 20 can generally be higher than the carrying capacity of the mobile robot 10.

The delivery system 60, using the transport devices 10, 20 can carry out a delivery process—i.e. can deliver items 5 to users 30.

In some embodiments, the mobile robots 10 can be fully autonomous, that is, can be configured to navigate, drive and carry out delivery processes in an autonomously. The controlling system 600, in such embodiments, can only provide the delivery tasks to the mobile robot 10—as planned in the delivery plan 15—and the mobile robot can autonomously carry out the at least one assigned delivery task.

In some other embodiments, the mobile robots 10 are not fully autonomous, that is, they may require human assistance during their operation—i.e. driving, navigating, carrying out the delivery task. In such embodiments, the controlling system 600 can allow a human operator to control or assist the mobile robots 10. For example, the controlling system 600 may provide remote controllers configured to remotely control the mobile robots 10 through small distances (e.g. 0-10 m) or long distances through a remote connection, e.g. Internet or cellular technology. The controlling system 600 may thus provide the delivery tasks according to the delivery plan 15 to the mobile robot 10 and/or human operator. In any case, the human operator may access the delivery task either through the mobile robot 10 or directly through the controlling system 600.

Same discussion is true for the mobile transport apparatus 20, which can comprise full automation, high automation, conditional automation, partial automation, drive assistance or no automation, by as defined by the Society of Automotive Engineers (SAE) in J3016 Autonomy Levels.

Put simply, the controlling system 600 can be configured to coordinate operation of the delivery system 60 and ensure that the delivery process is carried out as planned in the delivery plan 15.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-20. (canceled)

21. A method for routing a plurality of delivery items to a plurality of delivery locations by a plurality of transport devices, the method comprising:
(A) localizing the plurality of delivery items;
(B) determining the delivery locations for the plurality of delivery items; and
(C) a data processing device executing a genetic algorithm for outputting a routing plan comprising at least one of:
(i) assigning the transport devices to the delivery items; and/or
(ii) assigning the transport devices to times of delivery; and/or
(iii) routing the transport devices to the delivery locations.

22. The method of claim 21, wherein the determining in (B) further comprises determining a respective time of delivery or a respective time window of delivery for at least one of the plurality of delivery items.

23. The method of claim 21, further comprising providing different kinds of transport devices, the difference concerning at least one of:
(i) sizes of the transport devices; and/or
(ii) a number of delivery items the transport devices transport; and/or
(iii) a size of delivery items the transport devices transport; and/or
(iv) a way of travel the transport devices are configured to use.

24. The method of claim 23, wherein the providing different kinds of transport devices comprises providing a first transport device and a second transport device, wherein:
(i) the first transport device is a mobile robot; and
(ii) the second transport device is a transport apparatus; and
(iii) at least one of: the transport apparatus comprises a more voluminous carrying capacity than the mobile robot and/or the transport apparatus is configured to transport one or more mobile robots.

25. The method of claim 24, wherein the mobile robot travels in public roads, driveways, bike lanes, and/or sidewalks and at speeds below 30 km/h, or no more than 8 km/h, or no more than 6 km/h.

26. The method of claim 21, wherein (C) is performed iteratively and in each iteration a generation is generated and wherein said generation is a representation of the routing plan.

27. The method of claim 26, wherein the generating a generation comprises at least one of:
(i) combining at least two previous generations, wherein the combination of the at least two previous generations comprises inheriting features from the at least two combined previous generations, such as, from each of the at least two combined previous generations; and/or
(ii) performing changes on a previous generation, such as, randomly changing a feature of a previous generation; and/or
(iii) inheriting some features from a previous generation and recalculating rest of the features; and/or
(iv) adding features to a previous generation; and/or
(v) removing features from a previous generation.

28. The method of claim 26, wherein the generating a generation comprises performing changes on a previous generation, said changes comprising at least one of:
(i) randomly assigning a transport device to a delivery item; and/or
(ii) re-assigning a delivery item from one transport device to another; and/or
(iii) re-assigning at least two delivery items with different assigned transport devices to same transport device; and/or
(iv) assigning a delivery item from being delivered using one transport device to being delivered using different kinds of transport devices; and/or
(v) adding a delivery item and/or a respective route for delivering the delivery item; and/or
(vi) removing a delivery item and/or respective route for delivering the delivery item; and/or
(vii) swapping a time-wise ordering of two successive deliveries for a transport device; and/or
(viii) adding to the route for delivering a delivery item an intermediate stop at an energy station for providing energy to the assigned transport devices to complete the delivery of the respective delivery item; and/or
(ix) combining at least two routes for delivering at least two delivery items into a single route.

29. The method of claim 26, wherein (C) further comprises determining efficiency and constraint fulfilment of each generation and wherein efficiency and constraint fulfilment of a generation is determined based on at least one of:
(i) distance travelled by the transport devices to deliver the plurality of delivery items; and/or
(ii) time spent to deliver the plurality of delivery items; and/or
(iii) energy consumed by the transport devices to deliver the plurality of delivery items; and/or
(iv) number of transport devices required for delivering the plurality of delivery items; and/or
(v) number of human employees that can be involved in delivering the plurality of delivery items; and/or
(vi) accordance with regulations or laws, such as, traffic laws; and/or
(vii) cost of carrying out the delivery routing plan.

30. The method of claim 21, wherein (C) is repeated during travel of the transport devices for delivering the plurality of delivery items and the routing plan is changed during the travel of the transport devices for delivering the plurality of delivery items.

31. The method of claim 24, wherein the method further comprises: transferring at least one delivery item from a transport apparatus to a mobile robot.

32. The method of claim 24, wherein the method further comprises:
the transport apparatus carrying at least one mobile robot, wherein the at least mobile robot carries at least one delivery item; and
the transport apparatus transporting the at least one mobile robot to an intermediate location; and
unloading the at least one mobile robot at the intermediate location; and
the at least one mobile robot transporting the at least one delivery item to the respective delivery locations.

33. A system for routing a plurality of delivery items to a plurality of delivery locations by a plurality of transport devices, the system comprising:
(a) a controlling system configured for localizing the delivery items and localizing the delivery locations; and
(b) a computing system configured to execute at least one genetic algorithm for at least one of:
(i) assigning the transport devices to the delivery items; and/or
(ii) assigning the transport devices to times of delivery; and/or
(iii) routing the transport devices to the delivery locations;
(c) wherein the controlling system is configured to control the transport devices according to an output of the computing system.

34. The system of claim 33, wherein the controlling system is configured to determine a respective time of delivery or a respective time window of delivery for at least one of the plurality of delivery items.

35. The system of claim 33, wherein the routing system comprises different kinds of transport devices, the difference concerning at least one of:
(i) sizes of the transport devices; and/or
(ii) a number of delivery items the transport devices transport; and/or
(iii) a size of delivery items the transport devices transport; and/or
(iv) a way of travel the transport devices are configured to use.

36. Routing system according to claim 33, wherein the routing system comprises a first transport device and a second transport device, wherein:
(i) the first transport device is a mobile robot; and
(ii) the second transport device is a transport apparatus; and
(iii) the transport apparatus is configured to at least one of: comprise a bigger carrying capacity than the mobile robot and/or transport one or more mobile robots.

37. The system of claim 33, wherein the computing system is configured to receive logistic data and delivery request data wherein the logistic data comprises data related to the transport devices, such as, a list of transport devices and
the delivery request data comprises data related to the delivery items and delivery locations.

38. The system of claim 33, wherein
(i) the computing system is configured to output a delivery plan and wherein the delivery plan comprises for each delivery item a respective delivery location, a respective time of delivery, assigned transport devices for delivering the delivery item, and assigned route for delivering the delivery item; and
(ii) the controlling system is configured to receive the delivery plan that is output by the computing system.

39. The system of claim 33, wherein at least one transport device is fully-autonomous and the controlling system provides assigned delivery tasks by the computing system to the at least one fully-autonomous transport device and the at least one fully-autonomous transport device autonomously completes an assigned delivery task according to the output of the computing system.

40. The system of claim 33, wherein at least one transport device is nearly-autonomous and the controlling system provides assigned delivery tasks by the computing system to the at least one nearly-autonomous transport device and the at least one nearly-autonomous transport device assisted by the controlling system completes the delivery task according to the output of the computing system.
